(19) United States
(12) Patent Application Publication
(10) Pub. No.: US 2007/0088743 A1
(43) Pub. Date: Apr. 19, 2007

(54) Information processing device and information processing method

(75) Inventors: Osamu Kikuchi, Tokyo (JP); Chiori Ogasawara, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOSHIBA SOLUTIONS CORPORATION, Tokyo (JP)

(21) Appl. No.: 10/572,584

(22) PCT Filed: Sep. 19, 2003
(86) PCT No.: PCT/JP03/11990

§ 371 Date: Mar. 20, 2006

(51) Int. Cl. G06F 17/00

(52) U.S. Cl. 707/104.1

(57) ABSTRACT

An information processor according to the present invention includes: a research section extracting a first the key word from target information to be searched and searching for relevant information for regard to the translated first key word from searching target information; an assessment analysis section receiving a correlation between the target information to be searched including a using possibility of the relevant information for the target information to be searched and the relevant information; and a document generation section generating a document from the target information to be searched and the relevant information on the basis of the correlation received by the assessment analysis section. In the case where the searching target information is information of a specification filed patent application, and the generated document is a specification to be filing patent application, the correlation of the assessment analysis section further includes at least one or more of among “None assessment”, “Whether or not requirement to pursuit research”, “Right or wrong of diverting to proposals information”, and “Relevancy with information of the specification filed patent application”.

### FIELD OF THE INVENTION

The present invention relates to an apparatus and method for information processing in order to support projects, research, and filing of patent applications of a product.

### BACKGROUND OF THE INVENTION

At the start of the project and the technology development of a product, trend review of the industry and a research for domestic and foreign patents in order to protect one's own business has been conducted. The results of the market and patent research have been discussed and analyzed.

The steps of product planning, new technology development, and patent application filing will be described referring to FIG. 1.

First of all, in Step S901, an understanding of a new business method is grasped. Grasping the concept of the business method is mainly done by gathering management personnel, who conduct brainstorming in reference to relating the market research results and the market trends.

Next, in Step S902, an official notice (common knowledge of one skilled in the art) is researched and the Published examined patent application including the patent published application etc. that relate to the new business method is extracted by a person in charge of the filing of patent applications. In Step S903, the person in charge of the patent assesses the results of the official notice research. In Step S904, this assessment is fed back to the management personnel, and then the concept of the new business method is decided.

In Step S905, an idea of a specific invention of the new business method decided in Step S904 is generated by a member in the field composed of a person in charge of development, a person in charge of business, and a person in charge of operation etc.

In step S906, the member in the field makes proposals in order to file the patent applications, and files the patent applications in step S907 based on the specific idea generation for the invention outputted in step S905.

However, conventionally, since the Published examined patent applications obtained in step S902 often reach a great number, a systematic analysis cannot be achieved even if being discussed by one person in charge of the patent. In addition, even if plural persons in charge of the patent discussed the great number of Published examined patent applications each allotting it, the section that shared the results of review among the person in charge is scarce. Thus, it has been a rare case that the results are effectively used even if patent research is conducted.

Moreover, when the invention of improvement etc. are filed, the proposals might be described based on the patent applications specification filed in the past. In this case, the results of the patent research when filing applications in the past might be referred to. However, in the case of difference both of a person in charge of the patent of past applications and the person in charge of the patent of this application, in the case of no remainder of the past results of review, or in the case where it was not able to determine the past results of reviews because of the memo level even if the past results of reviews remained, an enough discussion has not been conducted.

Since the patent research required expertise in order to make the classification and the search formula the person in charge of the research of working full-time had conducted actually. In the case where the knowledge was not shared between the person in charge of the research and the management personnel, the official notice research with different directionality was conducted and then the backslide has been often generated as the research would be conducted again.

In addition, since the member in the field tried to devise the invention with the patentability in Step S905 shown in FIG. 1, there was a problem that contradiction has been caused in the business method decided by the management personnel and the invention proposed by the member in the field in Step S901 and Step S904, and has been generated the gap of directionality.

On the other hand, the technology that the patent map created by converting automatically the search file of various formats extracted from the search engine of the variable patent documents and the engineering data served inside and outside the country into the mastering table data for the patent and the technical information analysis by using the computer, constructing data bases integrated according to a technological subject, and using these is disclosed in Japanese patent laid open publication (kokai) No. 2001-92851.

According to Japanese patent laid open publication (kokai) No. 2001-92851, one united data bases can be created from the various databases, and the patent map can be created. However, since the database currently disclosed and registered are only constructed and integrated, it is nothing but the analysis of this data. Therefore, when the filing of patent applications specification and the proposals are made, it is impossible to the making support by picking up the part able to be used for another new filing of patent applications, and using the picked up data, like the present invention.

Moreover, according to Japanese patent laid open publication (kokai) No. 2002-7427, the publication data being provided on the outside is imported and stored, the search formula is made and registered, and the automatic search is executed, and the extracted search set is saved as second store information. The technology is disclosed that the level of importance is determined to the search set of the second store information, and the results are inputted.

According to Japanese patent laid open publication (kokai) No. 2002-7427, the other companies or its own patent publication data is imported from the external database and the automatic search is executed by using the registered search formula. However, it was able merely to construct and to integrate the database currently disclosed and registered, to analyze the results of the automatic search, to input the results of analysis, and only to reuse the results even in the other business segment etc. Therefore, according to Japanese patent laid open publication (kokai) No. 2002-7427, it is impossible to the making support by picking up the part able to be used for another new filing of patent application as the results of analysis, and by using it when the filing of patent application specification is made. Moreover, functions of the extraction of the key word and the generation of the search formula etc. from the natural language expanded by the idea generation support are not provided.

Therefore, the aim of the present invention is in order to provide an apparatus and method for information processing available for exploitation of a novel business, and development and enhancing of the product and the service, etc.

### SUMMARY OF THE INVENTION

To solve the above-mentioned problem, an apparatus for information processing according to the first characteristic of the present invention includes an idea generation support section configured: to relate unit information of needs of a supplier of a product and unit information of needs of a user to predetermined comment code; to relate unit information of seeds of the product required from the needs of the supplier and the needs of the user to the comment code; and to summarize the unit information of the needs of the supplier, the unit information of the needs of the user, and the unit information of the seeds of the product by using the comment code.

An apparatus for information processing according to the second characteristic of the present invention includes: a research section extracting a first key word from target information to be searched, and searching for relevant information for regard to the first keyword from searching target information; an assessment analysis section receiving a correlation between the target information to be searched including a using possibility of the relevant information for the target information to be searched and the relevant information; and a document generation section generating a document from the target information to be searched and the relevant information on the basis of the correlation received by the assessment analysis section.

An apparatus for information processing according to the third characteristic of the present invention includes a research section configured: to extract a first key word from target information to be searched; to search for relevant information for regard to the first key word from searching target information; to extract a second key word for characterizing the relevant information; and to summarize the relevant information by summary item including one or more of the first key word and the second key word.

An apparatus for information processing according to the fourth characteristic of the present invention includes a foreign document analysis section configured: to compare searching target information; to compares words used by each country; and to generate translation with an original in each country corresponding to the words, in same searching target information by contents described by using language in each country.

An apparatus for information processing according to the fifth characteristic of the present invention includes a research section configured: to extract a first the key word from target information to be searched; to translate the first key word into a prescribed language; and to search for relevant information for regard to the translated first key word from searching target information.

An apparatus for information processing according to the sixth characteristic of the present invention includes the step of: pursuing needs of a supplier for a product; pursuing needs of a user for the product; and pursuing seeds of the product to be realizable from the needs of the supplier and the needs of the user.

An apparatus for information processing according to the seventh characteristic of the present invention includes the step of: extracting a first key word from target information to be searched, and searching for relevant information for regard to the first key word from searching target information; receiving a correlation between the target information to be searched including a using possibility of the relevant information for the target information to be searched and the relevant information; and generating a document from the target information to be searched and the relevant information on the basis of the correlation.

An apparatus for information processing according to the eighth characteristic of the present invention includes the step of: extracting a first key word from target information to be searched, searching for relevant information for regard to the first key word from searching target information, and extracting a second key word for characterizing the relevant information; and summarizing the relevant information by summary item including one or more of the first key word and the second key word.

An apparatus for information processing according to the ninth characteristic of the present invention includes the step of: comparing searching target information; comparing words used by each country; and generating translation with an original in each country corresponding to the words, in same searching target information by contents described by using language in each country.

An apparatus for information processing according to the ninth characteristic of the present invention includes the step of: extracting a first the key word from target information to be searched; translating the first key word into a prescribed language; and searching for relevant information for regard to the translated first key word from searching target information.

### BRIEF DESCRIPTION OF THE DRAWINGS

FIG. 1 is a flow chart for describing process in the case of product planning and the technology development conducted newly.

FIG. 2 is a flow chart for describing information processing method according to a preferred of the present invention.

FIG. 3 is a system block configuration of an information processing system according to the preferred embodiment of the present invention.

FIG. 4 is a functional block chart of the information processor according to the preferred embodiment of the present invention.

FIG. 5 is an illustration showing an example of data structure and example of data of a constituent element code storage unit according to the preferred embodiment of the present invention.

FIG. 6 is an illustration showing an example of data structure and example of data of an idea generation comment code storage unit according to the preferred embodiment of the present invention.

FIG. 7 is an illustration showing an example of data structure and example of data of a synonym dictionary storage unit according to the preferred embodiment of the present invention.

FIG. 8 is an illustration showing an example of data structure and example of data of first analysis results of idea generation storage unit according to the preferred embodiment of the present invention.

FIG. 9 is a flow chart showing detailed processing executed by first idea support method according to the preferred embodiment of the present invention.

FIG. 10 is an illustration showing an example of a window for describing a theme and words on cards in the first idea generation support section according to the preferred embodiment of the present invention.

FIGS. 11A to 11C are flow charts showing the technique for deciding a business method in the first idea generation support section according to the preferred embodiment of the present invention.

FIG. 12 is an illustration showing an example of a window for indicating an idea generation results of analysis in the first idea generation support section according to the preferred embodiment of the present invention.

FIG. 13 is an illustration showing an example of a window for describing the theme and the words on the cards about each of seeds and needs in the first idea generation support section according to the preferred embodiment of the present invention.

FIG. 14 is an illustration showing an example of data structure and example of data of a search parameter storage unit according to the preferred embodiment of the present invention.

FIG. 15 is an example of a distribution chart of the relevant information summarized by using first key word and second key word indicated in the research section according to the preferred embodiment of the present invention.

FIG. 16A is an illustration showing an example of a patent map generated in the research section according to the preferred embodiment of the present invention, and FIG. 16B is an example of a patent map more detailed generated for one bubble of the patent map shown in FIG. 16A.

FIGS. 17A and 17B are flow charts for describing detailed processing executed by the research section according to the preferred embodiment of the present invention.

FIG. 18 is an example of an official notice indicating window indicated by the research section according to the preferred embodiment of the present invention.

FIG. 19 is an example of data structure and example of data of an assessment code storage unit according to the preferred embodiment of the present invention.

FIG. 20 is an example of data structure and example of data of an assessment analysis results storage unit according to the preferred embodiment of the present invention.

FIG. 21 is a flow chart for describing detailed processing executed by the assessment analysis section according to the preferred embodiment of the present invention.

FIG. 22 is an example of a publication list indicating window indicated by the assessment analysis section according to the preferred embodiment of the present invention.

FIG. 23 is an example of an official notice assessment input window indicated by the assessment analysis section according to the preferred embodiment of the present invention.

FIG. 24 is an example of the publication list indicating window reflected in the assessment of the official notice inputted in the window shown in FIG. 23.

FIG. 25 is an example of data structure and example of data of second analysis results of idea generation storage unit according to the preferred embodiment of the present invention.

FIG. 26 is a flow chart for describing detailed processing executed by a second idea generation support section according to the preferred embodiment of the present invention.

FIG. 27 is a flow chart for describing detailed processing executed by a documentation support section according to the preferred embodiment of the present invention.

FIG. 28 is an example of an invention proposals making support window indicated by a documentation support section according to the preferred embodiment of the present invention.

FIG. 29 is an example of a prior art register window indicated by the documentation support section according to the preferred embodiment of the present invention.

FIG. 30 is an example of data structure and example of data of a foreign language bilingual storage unit according to the preferred embodiment of the present invention.

FIG. 31 is a flow chart for describing detailed processing executed by a foreign document analysis section according to the preferred embodiment of the present invention.

FIG. 32 is one example of the patent family comparison window for relating words of Japanese to words of foreign language indicated by the foreign document analysis section according to the preferred embodiment of the present invention.

FIG. 33 is an example of a window translated from the patent family comparison window shown in FIG. 32 into a prescribed language and indicates it.

FIG. 34 is a flow chart showing a processing of foreign documentation executed by the information processor according to the preferred embodiment of the present invention.

FIG. 35 is an example of a window indicating relevant information of the foreign country searched by a research section in the information processor according to the preferred embodiment of the present invention.

FIG. 35 is an example of a window translated from the relevant information of the foreign country shown in FIG. 35 into a prescribed language and indicates it.

FIG. 37 is an example of a foreign country invention proposals making support window indicated by a foreign documentation support section according to the preferred embodiment of the present invention.

### PREFERRED EMBODIMENTS OF THE INVENTION

Next, various embodiments of the present invention will be described herein below with reference to the accompanying drawings. In the description of the following drawings, the same or similar reference numerals are applied to the same or similar parts and elements.

In the present invention, “Product” is not limited to industrial products, and includes the service and the business method using the software program and the for example Internet, etc. As just described, the information processor according to the embodiments of the present invention supports the development of a novel business, the implementation of the product in a novel country of an existing business, and the like.

### Preferred Embodiment

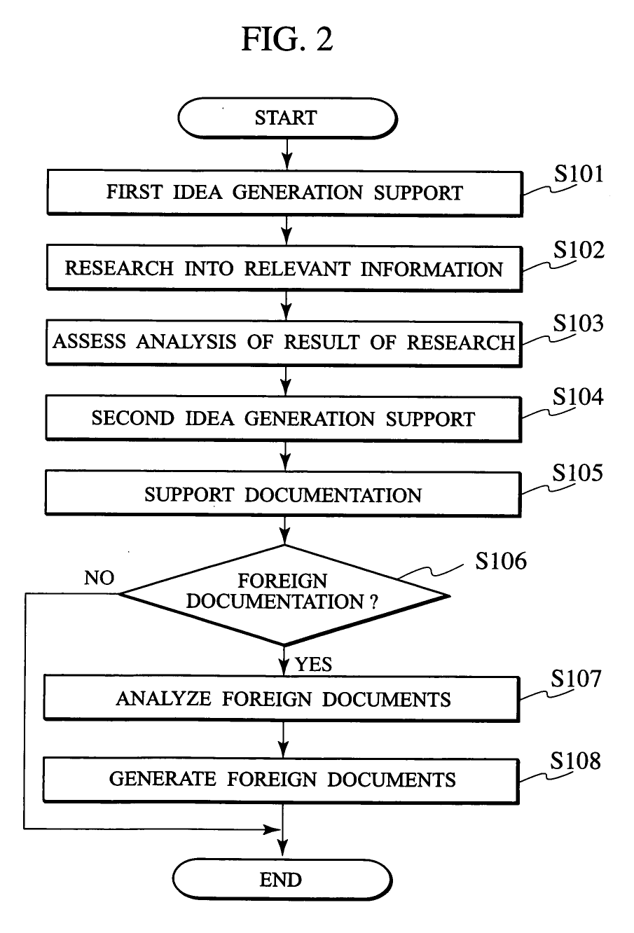

The computer implemented method for information processing according to the preferred embodiment of the present invention will be described referring to FIG. 2.

First of all, an idea generation of a novel product and novel business method is supported in Step S101. In Step S102, a new industry trend related to the business method and the research of the official notice are executed, and the relevant information related to the new business is acquired. Next, in Step S103, the results of the research acquired in Step S102 is inspected, and assessed and analyzed.

Moreover, in Step S104, the idea generation related to the novel business further supported based on the assessment and the analysis of the results of the research implemented in Step S103. In Step S105, project proposals and a document of the invention proposals etc. are generated.

In addition, it is determined whether or not to generate a foreign document in Step S106. If the foreign document is not generated, this information processing is ended. If a foreign document is generated, in Step S107, the relevant information described in the foreign language like the patent family etc. of the predetermined application is researched, and then the words of a foreign document is analyzed when there is a relevant information described in the foreign language. In Step S108, the foreign document described by the country that uses it by optimal words is made as well as Step S105 referring to the results of analysis of Step S107.

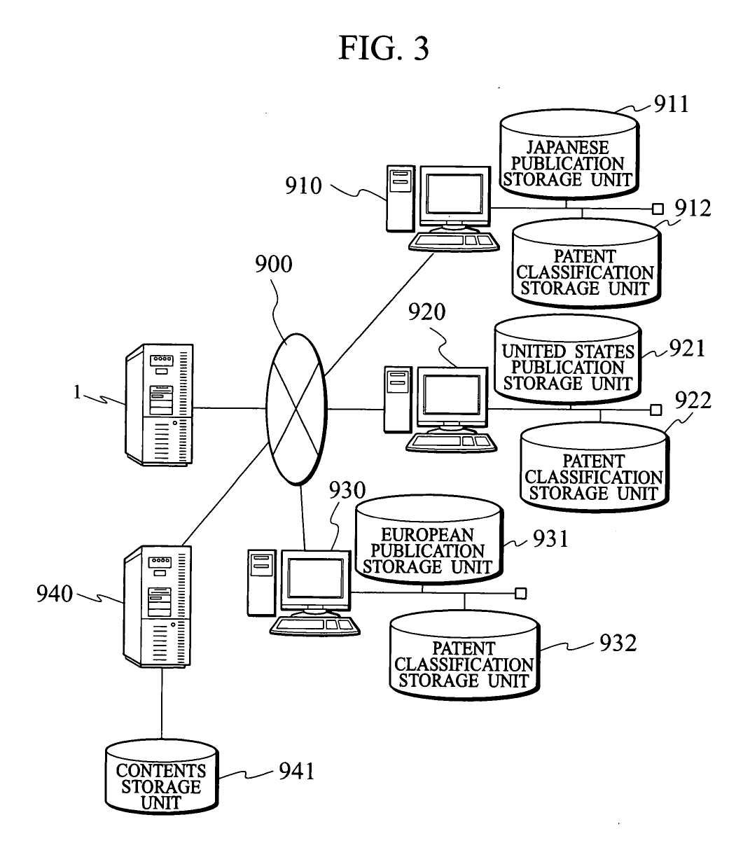

Information processor 1 according to the preferred embodiments of the present invention will be explained in detail referring to FIGS. 3 to 37.

As shown to FIG. 3, the information processing system according to the preferred embodiments of the present invention includes the information processor 1 for processing information, a Japanese Patent Office server 910 provided by the Japanese Patent Office, a United States Patent and Trademark Office server 920 provided by United States Patent and Trademark Office, a Europe Patent Office server 930 provided by Europe Patent Office, and contents server 940 for providing various contents. The information processor 1, the Japanese Patent Office server 910, the United States Patent and Trademark Office server 920, the European Patent Office server 930, and the contents server 940 can communicate between each other through Communication networks 900 of the Internet and the personal computer communication, etc. As not shown in figure, the servers are not only servers of the public organizations, but also servers for profit may be connected for searching retrieves information of the published examined patent application and the market trend etc.

The Japanese Patent Office server 920 includes a Japanese publication storage unit 911 storing publications such as the Japanese patent Laid Open Publication and the published examined patent applications filed in a Japan, and a patent classification storage unit 912 storing patent classification such as the International Patent Classifications (IPC) and the File forming Term (F-term) etc. The United States Patent and Trademark Office server 920 and the European Patent Office server 930 also include the composition similar to Japanese Patent Office server 910.

The contents server 940 includes contents storage unit 941 storing web pages provided by enterprises, industry trend information provided by organ of surveys, new release information, stock price information, patent infringement case information, information of newspapers and magazines, etc. and information written in the Bulletin Board System etc. described by the user. The contents server 940 may be achieved by a single computer, and also may be achieved by plural computers.

The information processor 1, the Japanese Patent Office server 910, United States Patent and Trademark Office server 920, Europe Patent Office server 930, and the contents server 940 are achieved by installing software programs for the predetermined processing in the general computer.

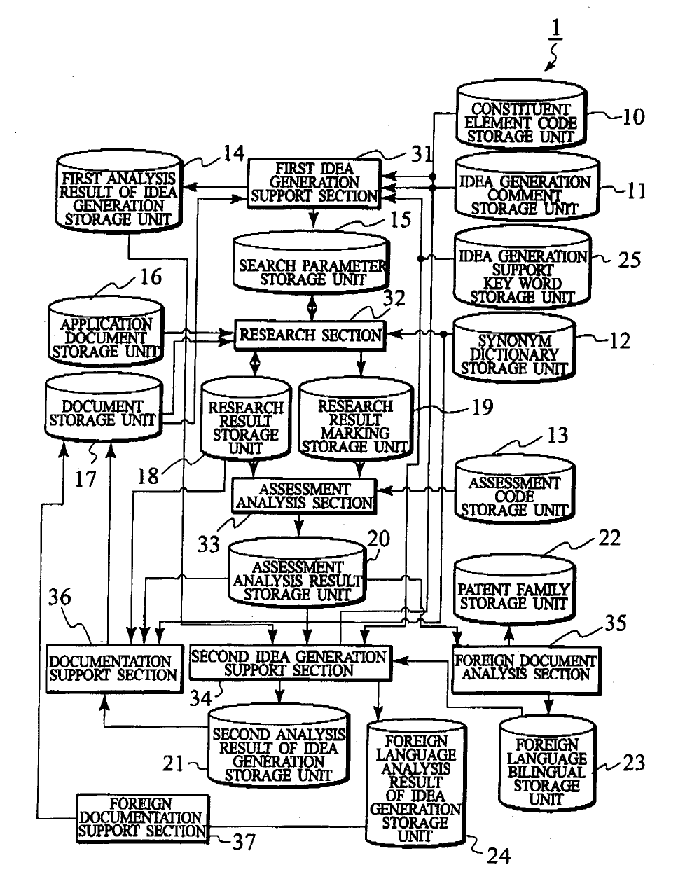

The function of the information processor 1 will be described referring to FIG. 4. The information processor 1 includes a constituent element code storage unit 10, an idea generation comment code storage unit 11, a synonym dictionary storage unit 12, a assessment code storage unit 13, a first analysis results of an idea generation storage unit 14, a search parameter storage unit 15, an application document storage unit 16, a document storage unit 17, a research results storage unit 18, a research results marking storage unit 19, a assessment analysis results storage unit 20, a second analysis results of idea generation storage unit 21, patent family storage unit 22, a foreign language bilingual storage unit 23, foreign language analysis results of idea generation storage unit 24, an idea generation support key word storage unit 25, a first idea generation support section 31, a research section 32, an assessment analysis section 33, second idea generation support section 34, a foreign document analysis section 35, a documentation support section 36 and a foreign documentation support section 36.

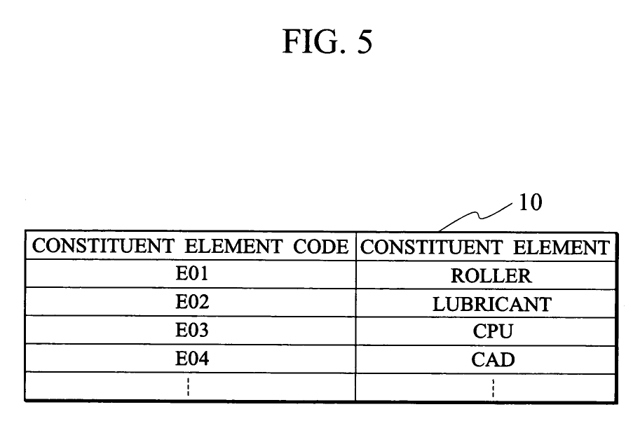

The Constituent element code storage unit 10 is a storage unit for storing product configuration elements generated ideas by the information processor 1 according to the preferred embodiments of the present invention relating to the constituent element code. Here, the constituent elements are not limited to a physical element, but also can be medicines, production lines, infrastructures, parts, and the like. As shown in FIG. 5, for example, in the case where the product is a press apparatus, the roller and the lubricant etc. of the press apparatus are rendered as indexes and stored.

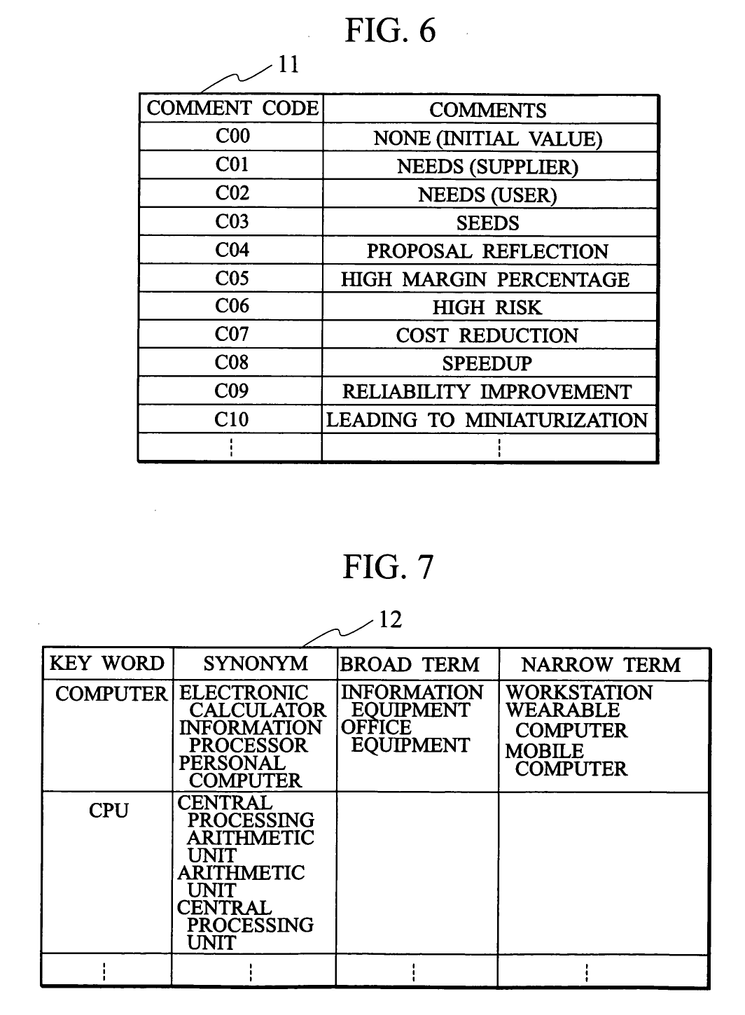

The idea generation comment code storage unit 11 is a storage unit for storing inventions generated ideas and comments corresponding to unit information of the idea by the first idea generation support section and second idea generation support section 34, etc. For example, as shown in FIG. 6, the idea generation comment code storage unit 11 stores comment codes and comments corresponding to the comment codes. Here, the assessment indexes of the ideas such as “Needs (supplier)”, “Needs (user)”, “Seeds”, and “Proposal reflection” is stored.

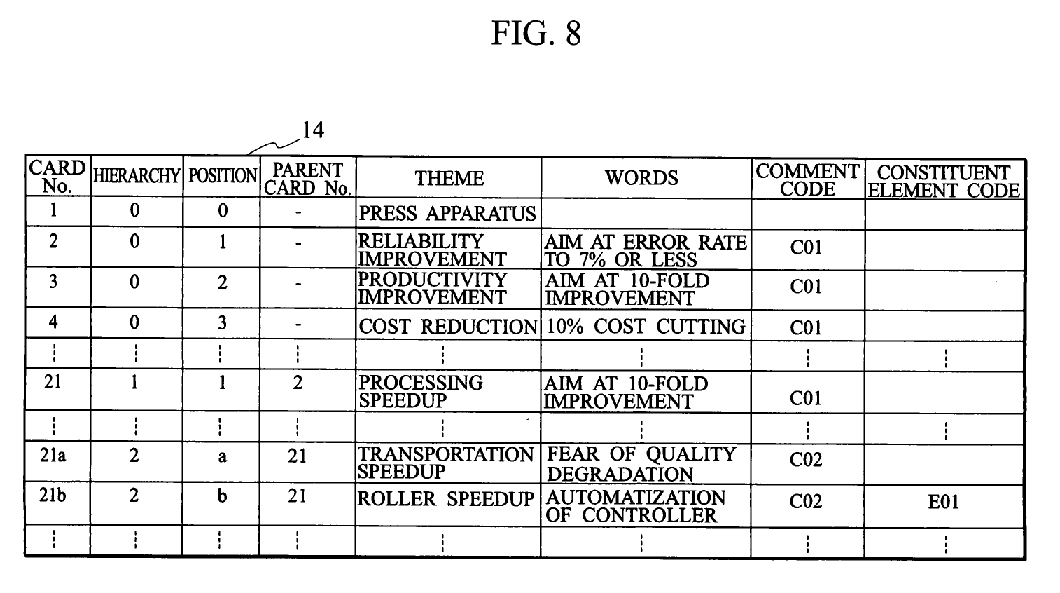

The synonym dictionary storage unit 12 stores the synonym to one key word used when the research section 32 etc. generates the search formula. Different words can be absorbed into document about filing application etc, and a more adequate search can be achieved, by generating the search formula including these synonyms. As shown in FIG. 7, for example, the items that consider generic concepts or more specific concepts of languages of the synonym, the broad term, and the narrow term of the words, etc. is provided for one key word. Here, for example, against the keyword “Computer”, the synonyms are “Electronic calculator”, “Information processor”, and “Personal computer”, and the broad terms are “Information equipment”, and “Office equipment”, and narrow terms are “Workstation”, “Wearable computer”, and “Mobile computer”.

The application document storage unit 16 stores information for relating to the filed application of the specifications, the amendments, the arguments, and the like.

The Document storage unit 17 is a storage unit for storing the document information of the project proposals etc. that put information acquired from the results of the research together in report form, and the invention proposals information on excavation of the invention for the patent application. In addition, when the patent application is filed, the invention proposals information is related by the application number etc. of the application specification stored in the application document storage unit 16. This invention proposals information is information generated through the business method idea generation and the invention idea generation, etc. executed by the information processor 1 according to the preferred embodiments of the present invention. In addition, all acquired information such as the research of the official notice and the market, the comment on the research, and the patent family of the foreign applications etc. are related and stored preferably.

The idea generation support key word storage unit 25 urges inventor's idea in the first idea generation support section 31 and the second idea generation support section 34, and stores the key words for inspection of the ideas, such as “what's going on in the case of reducing?” and “Technical know-how for reducing the manpower?” etc.

As not shown in the figure, the information processor 1 includes output units such as display etc., input units such as mouse and keyboards etc., and communication control units such as LAN cards and modems etc.

### First Idea Generation Support Section

First of all, the first idea generation support section of an information processor 1 according to the preferred embodiments of the present invention will be described referring to FIG. 4.

The first idea generation support section 31 is a section for urging to inspect a novel business and a novel product referring to at least one of needs of user, seeds of development, the industry trend, and for storing unit information inspected idea in the first analysis results of the idea generation storage unit 14.

Here, “Unit information” is a conceived individual idea, and the idea to the product extends by gathering plural unit information.

Moreover, the first idea generation support section may hierarchically relate to each of the conceived unit information, and may store in the first analysis results of the idea generation storage unit 14.

In addition, the first idea generation support section 31 may relate the constituent element code and the comment code to the unit information of supplier's needs of the product and the unit information of user's needs referring to constituent element code storage unit 10 and idea generation comment code storage unit 11, and may relate the constituent element and the comment code also to unit information of seeds of the product required from the supplier's needs and the user's needs. In this case, it is possible to indicate effective constituent elements etc. by summarizing the unit information of seeds of supplier's needs, the unit information of user's needs, and the unit information of the product by using the constituent element code and the comment code.

In addition, the first idea generation support section may urge the investigation of the unit information by indicating information of idea generation support key word storage unit 25 that stores the key word for supporting the inspection about the elements of the invention.

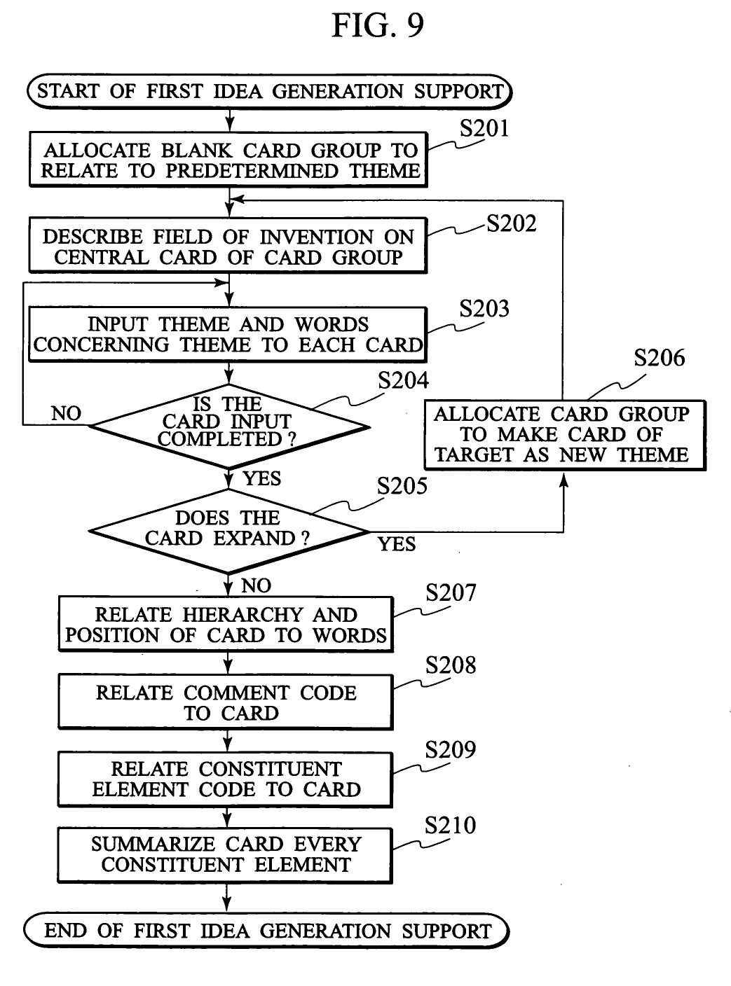

The first analysis results of the idea generation storage unit 14 stored the results of the first idea generation support section 31, as shown in FIG. 8, stores a card number, a hierarchy, a position, and a parent card number of a high-ranking hierarchy for specifying the unit information of the idea, and the theme of the card, words that are a detailed description related to the theme, a comment code related referring to the idea generation comment code storage unit 11, constituent element code to relate to the card referring to relates the constituent element code storage unit 10, and the like.

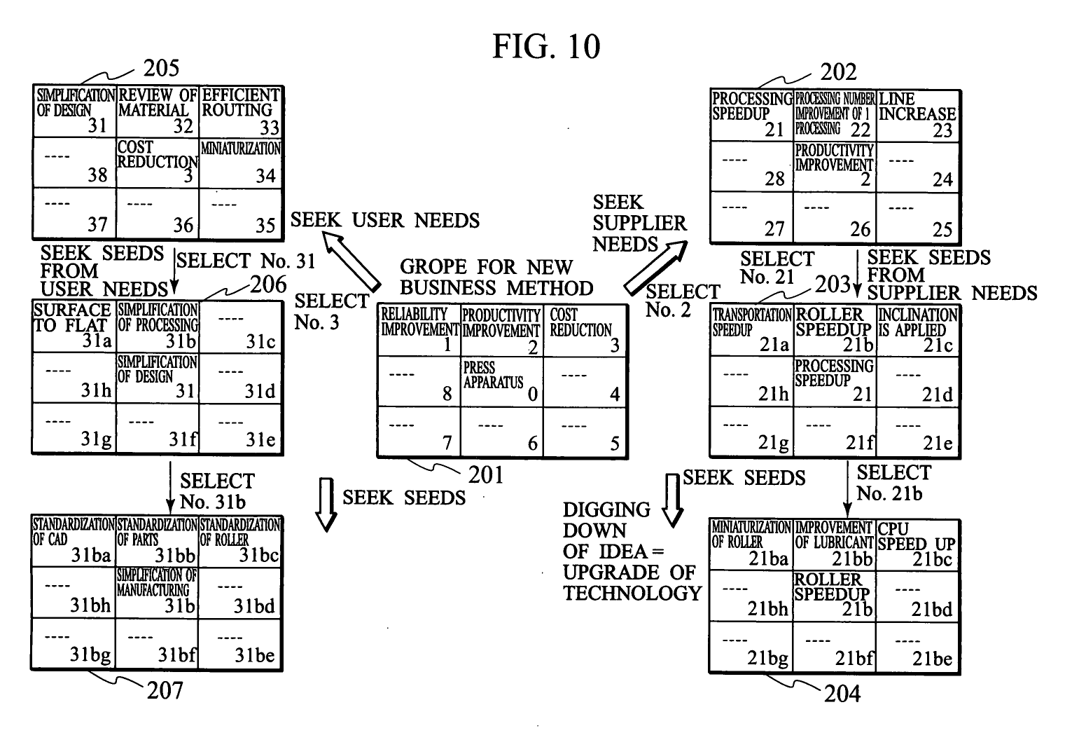

Detailed processing of the first idea generation support section 31 according to the preferred embodiments of the present invention will be described referring to FIG. 9.

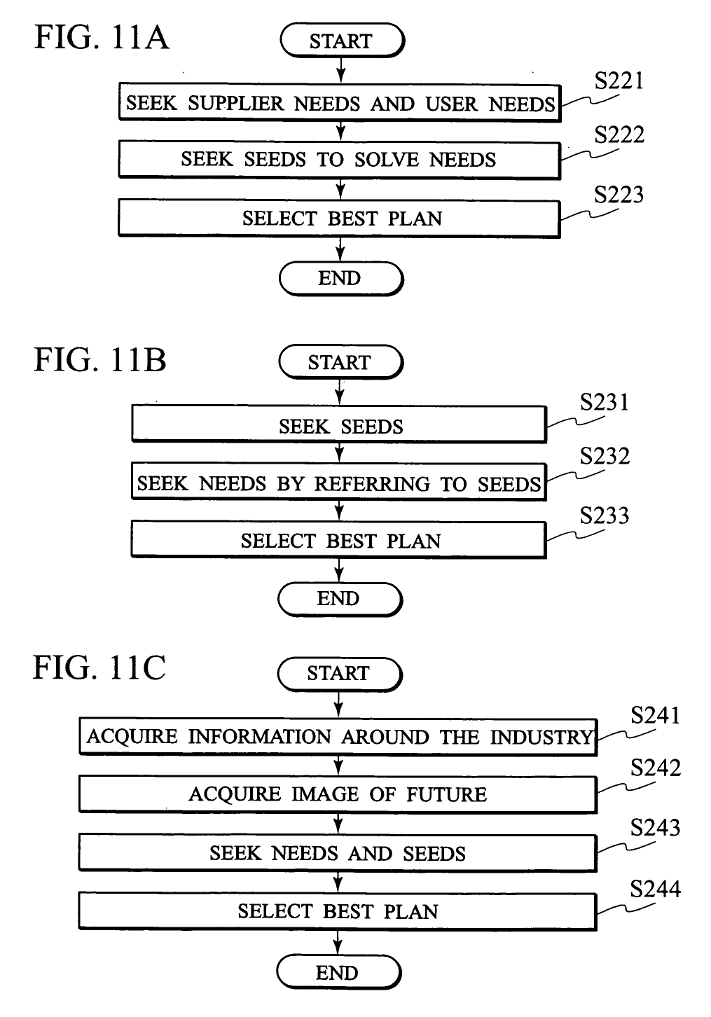

First of all, in step S201, the blank card group to relate to the theme of conceived product and business method is allocated to the display. At this time, for instance, by allocating three cards in lengthwise and horizontal direction, total of nine cards are allocated as shown to the first card group 201 in FIG. 10. In addition, in Step S202, the theme of the field of invention and the conceived business method is described on a center card of the card group. Here, as shown to FIG. 10, the business method will be inspected about “Press apparatus”.

Next, in step S203, the theme and the words concerning the theme are input to each card. Step S203 is repeated until the input of the theme and the word completes the allocated card in step S204. Here, all eight cards may be input, or only one card also may be input.

When the input of the words is completes in Step S204, it is determined whether there is expanding in addition about the predetermined card in Step S205. If there is expanding, the card group that assumes the card of the target to be a new theme is newly allocated in Step S206.

In addition, in step S202, the card of card number “2” of the first card group 201, that is, the card described as “Productivity improvement” is indicated in the center of the second card group 202. Furthermore, in step S203, the theme for regard to “Productivity improvement” is described in the individual card provided in the second card group 202. In this manner, the card is structured into a hierarchy, and the idea generation support of the business method is made more specific.

In step S205, if the card is not expanded any further, the hierarchy and the position of the card are related to the description contents of the card such as the theme and the words, and then stored it in the first analysis results of the idea generation storage unit 14 in step S207.

In addition, the comment code stored in the idea generation comment code storage unit 11 is related to each card stored at step S207, and then stored it in the first analysis results of the idea generation storage unit 14 in step S208.

On the other hand, the constituent element code stored in constituent element code storage unit 10 just as is the case with step S208 is related in step S209. In addition, the card is summarized in step S210 on the basis of the constituent element code related at step S209. The needs, seeds, and the advantage, etc. corresponding to the constituent element can be displayed in list form by summarizing by the constituent element code.

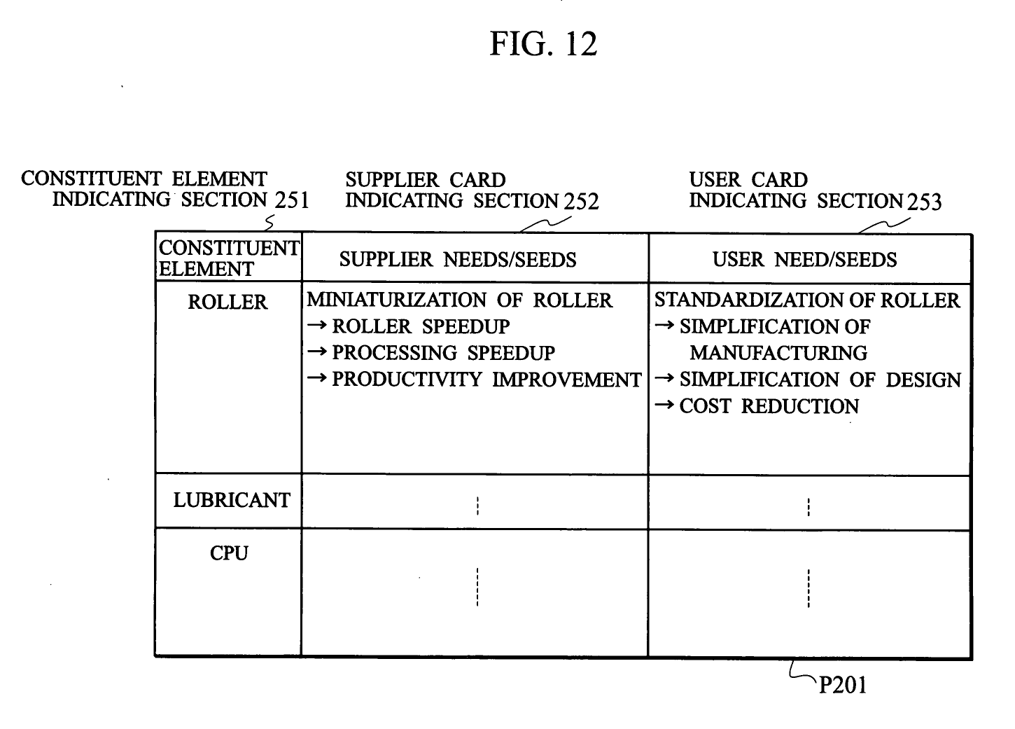

There are methods as shown in FIGS. 11A to 11C in the case of groping for the business method.

The method shown in FIG. 11A is a method for settling on the business method from the customers' needs. Here, first, the customers' needs are sought in step S221. Next, the technical seeds to solve the customers' needs are sought in step S221. And then, the preferred plan is selected in step S223. In the case of the method shown in FIG. 11A, it is possible to propose the business method that agrees with the customers' needs.

The method shown in FIG. 11B is a method for settling on the business method from the technical seeds. Here, first, the seeds are sought in step S231 by reviewing the practicable technology. The needs are sought referring to the seeds in step S232. And then, the preferred plan is selected in step S233. In the case of the method shown in FIG. 11B, it is possible to propose the business method for putting the technology to full use.

The method shown in FIG. 11C is a method for settling on the business method from the trends etc. of the industry. Here, first, the news sources etc. are collected and information around the industry is acquired in step S241. The business method in the future is predicted in step S242. In step S243, the predicted needs and the seeds for the business method are sought. And then, the preferred plan is selected in step S244. In the case of the method shown in FIG. 11C, it is possible to propose the long-term business method considered for the transition of the needs and the seeds.

Next, the idea generation method for the business method will be described detailed referring to FIG. 10. The case of the business method settled from the needs of the supplier and the needs of the user as shown in FIG. 11A and FIG. 11B will be described here.

First of all, the first card group 201 is allocated. Here, an understanding of a business method of “Press apparatus” is grasped such as described in card number “0” of the first card group 201. For example, the theme “Productivity improvement” is inputted to the card of card number “2” as a supplier's needs related to “Press apparatus” here. At this time, “C01” is related to the card of card number “2” as the comment code. In addition, the words that relates to the theme like the grounds, the purpose, and the background, etc. for which “Productivity improvement” is necessary such as “Productive efficiency 10% improvement” is inputted to the card of card number “2”.

Here, when the card of card number “2” described as “Productivity improvement” is selected, the second card group 202 that centers on the card of card number “2” of the first card group 201 is allocated. At this time, the second card group 202 is defined as the hierarchy structure, so that the parent card of the second card group 202 is card number “2” of the first card group 201. The advance and the problem, etc. concerning “Productivity improvement” are described on each card of the second card group 202. In addition, here, when card number “21” of the card secondarily group 202 is selected, the third card group 203 that centers on card number “21” of the second card group 202 is allocated and the detailed supplier's needs concerning “Processing speedup” are filled in here. Thus, the supplier's needs are sought.

In addition, the seeds to satisfy the supplier's needs are sought for the supplier's needs described in the first card group 201, the second card group 202, and third card group 203 etc. At this time, the fourth card group 204 that centers on card number “21b” of the third card group 203 is allocated to seek the seeds for achieving for instance, “Roller speedup” described in the card of card number “21b” of the third card group 203. “Roller speedup” is described on a center card of the fourth card group 204, and a technically possible thing to raise processing speed is described on each card of the fourth card group 204. In addition, as not shown in figure, when the card of card number “21ba” of the fourth card group 204 is selected for example, a new card group that centers on card number “21ba” of the fourth card group 204 may be allocated. Thus, the seeds for solving the supplier's needs are sought.

The various methods for achieving “Roller speedup” and the code of the constituent element that the regard of the methods are filled n on each card of the fourth card group 204. For example, the card of card number “21 ba” is filled as “Miniaturization of the roller”, and is related the constituent element code “E01”. Moreover, the card of card number “21bb” is filled as “Improvement of the lubricant”, and is related the constituent element code “E02”.

On the other hand, the theme “Cost reduction” is inputted to the card of card number “3” of the first card group 201 as the user's needs. At this time, “C02” is related to the card of card number “3” as a comment code. In addition, the words that relate to the theme like the grounds, the purpose, and the background, etc. for which “Cost reduction” is necessary such as “Cost 5% reduction” are inputted to the card of card number “3”.

Here, when the card of card number “3” described as “Cost reduction” is selected, the fifth card group 205 that centers on the card of card number “3” of the first card group 201 is allocated. At this time, the fifth card group 205 is defined as the hierarchy structure, so that the parent card of the fifth card group 205 is card number “3” of the first card group 201. The advance and the problem, etc. concerning “Cost reduction” are described on each card of the fifth card group 205. In addition, here, when card number “31” of the fifth card group 205 is selected, the sixth card group 206 that centers on card number “31” of the fifth card group 205 is allocated and detailed user's needs concerning “Simplification of the design” are filled in here. Thus, the user's needs are sought.

In addition, seeds to satisfy the user's needs are sought for the user's needs described in the first card group 201, the fifth card group 205, and sixth card group 206 etc. At this time, the sixth card group 206 that centers on card number “31b” of the seventh card group 207 is allocated to seek the seeds for achieving for instance, “Simplification of Manufacturing” described in the card of card number “31b” of the sixth card group 203. “Simplification of Manufacturing” is described on a center card of the seventh card group 207, and a technically possible thing to raise processing speed is filled on each card of the seventh card group 207. In addition, when the card of card number “31bc” of the seventh card group 207 is selected for example, a new card group that centers on card number “31bc” of the seventh card group 207 may be allocated. Thus, the seeds for solving the user's needs are sought.

The methods for achieving “Simplification of Manufacturing” and the code of the constituent element that the regard of various methods are filled in on each card of the seventh card group 207. For example, the card of card number “31ba” is filled as “Standardization of CAD”, and is related the constituent element code “E04”. Moreover, the card of card number “31bc” is filled as “Standardization of the roller”, and is related the constituent element code “E01”.

As for each card shown to FIG. 10, the comment code of idea generation comment code storage unit 11 related to the comments such as “Needs (supplier)”, “Needs (user)”, and “Seeds” by describing the card is corresponded. Plural comment codes may be corresponded to one card.

In addition, the constituent element code of constituent element code storage unit 10 related to the constituent element to which the card relates is corresponded as for each card shown in FIG. 10. Plural constituent element codes may be corresponded to one card.

Moreover, although the simple hierarchy structure that one parent card is related to one child card is described in FIG. 10, the parent-child relation may has a network structure. For example, the one parent card may be related to plural child cards, one child card may be related to plural parent cards, or the child card may be related mutually. The parent-child relation of these cards is stored in the first analysis results of the idea generation storage unit 14.

Each card group shown in FIG. 10 may indicate for the list in display unit, or may indicate each card group separately for the windows.

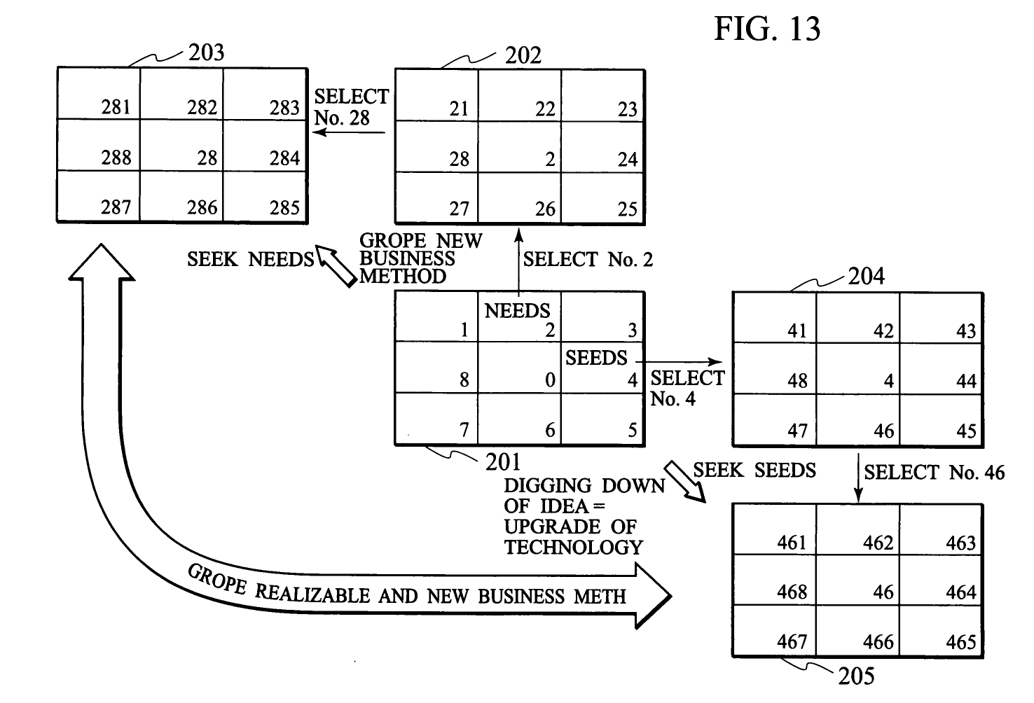

A constituent element summary window P201 showing the results of summarizing each card shown in FIG. 10 by using the constituent element code will be described referring to FIG. 12.

The constituent element summary window P201 includes a constituent element indicating section 251 for indicating the constituent element, a supplier card indicating section 252 for indicating information of the supplier card of supplier's needs and seeds that relate to the constituent element, and a user card indicating section 253 for indicating information of the user card of user's needs and seeds that relate to the constituent element.

More specifically, the card of card number “21ba” of the fourth card group 204 is extracted as a supplier card that relates to the constituent element of the roller. “Miniaturization of the roller” described in this card is indicated as the supplier card. In addition, in FIG. 12, “Roller speedup” described in card number “21b” that is the parent card of card number “21ba” is indicated, and the theme of the parent card is described similarly preferably.

On the other hand, the card of card number of the seventh card group 207 that is “Standardization of the roller” is extracted as a user card that relates to the constituent element of the roller. “Standardization of the roller” described in this card is indicated as a user card. “Simplification of the manufacturing” described in card number “31b” that is the parent card of card number “31ba” is indicated, and the theme of the parent card is described similarly preferably.

As shown to FIG. 12, it is easy to estimate the needs and the seeds of each constituent element by extracting and displaying the supplier card and the user card of each constituent element. Moreover, since “Constituent element efficient when improving” and “Constituent element that the supplier needs are corresponding to the user need”, etc. can be estimated by comparing cards related to an individual constituent element, it is possible to support for granting of the priority in the product development.

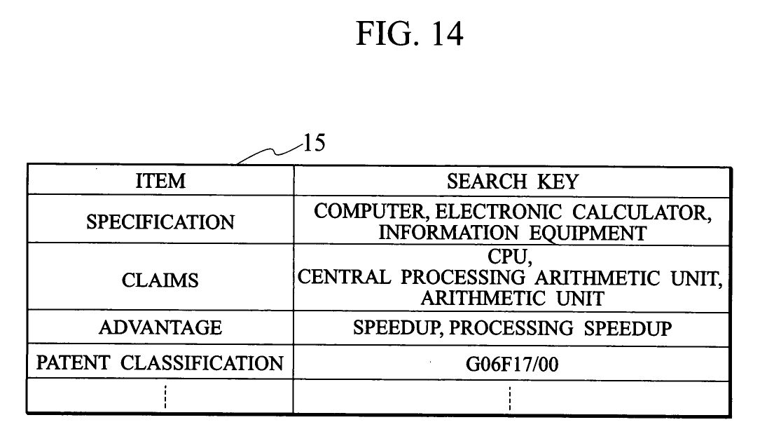

Moreover, there is a decision method for the business method shown to FIG. 13, which is different from the method shown in FIG. 10 and FIG. 11. For example, in the first card group 201, the needs and the seeds are proposed, and groped for a specific idea about of each. In addition, there is also a method that gropes for a realizable business method that the needs agree with the seeds when the idea is shown.

### Research Section

Next, research section 32 of the information processor 1 according to the preferred embodiments of the present invention will be described referring to FIG. 4.

The research section 32 is a section that extracts the first key word from search target information, and searches the relevant information for regard to the first key word from search target information. Here, “Search target information” is information conceived by the first idea generation support section 31, and is a theme of the card and information of the word etc. shown in FIG. 10 specifically. Moreover, “Search target information” is information stored in the database for searching information, and for example, corresponds to the Japanese publication storage unit 911, the United States publication storage unit 921, and the European publication storage unit 931 shown in FIG. 3, and corresponds to the application document storage unit 16 and the document storage unit 17 shown in FIG. 4, etc.

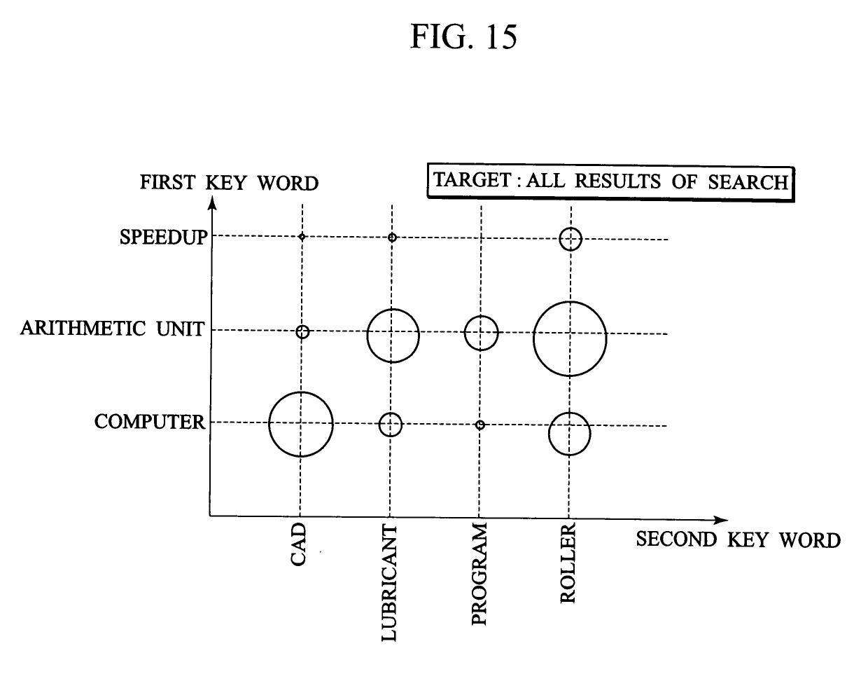

The research section 32 generates search parameters as shown to FIG. 14 on the basis of the first key word extracted from search target information, and stored the search parameters in the search parameter storage unit 15. When a general market research is executed, the search parameter storage unit 15 doesn't set the search target item, and stores only the search key. Moreover, when information filed patent application is collected, the search target item of “Specification”, “Claims”, “Advantage”, and “Patent classification”, etc. as shown in FIG. 14 is related to the search key searched by using the item, and stored. In addition, the database of the search target may be specified such as the Japan Patent Office servers 910 and the contents servers 940. Although only the parameter of the search condition is described in FIG. 14, the form of the search formula such as “SELECT ***” for querying the database may be stored.

The research section 32 further stores the relevant information for searching for the market situation and the official notice concerning the idea in the research results storage unit 18 searched by using the searching parameter showing in FIG. 14, and extracts the second key word that characterizes the official notice and stores in the research results marking storage unit 19.

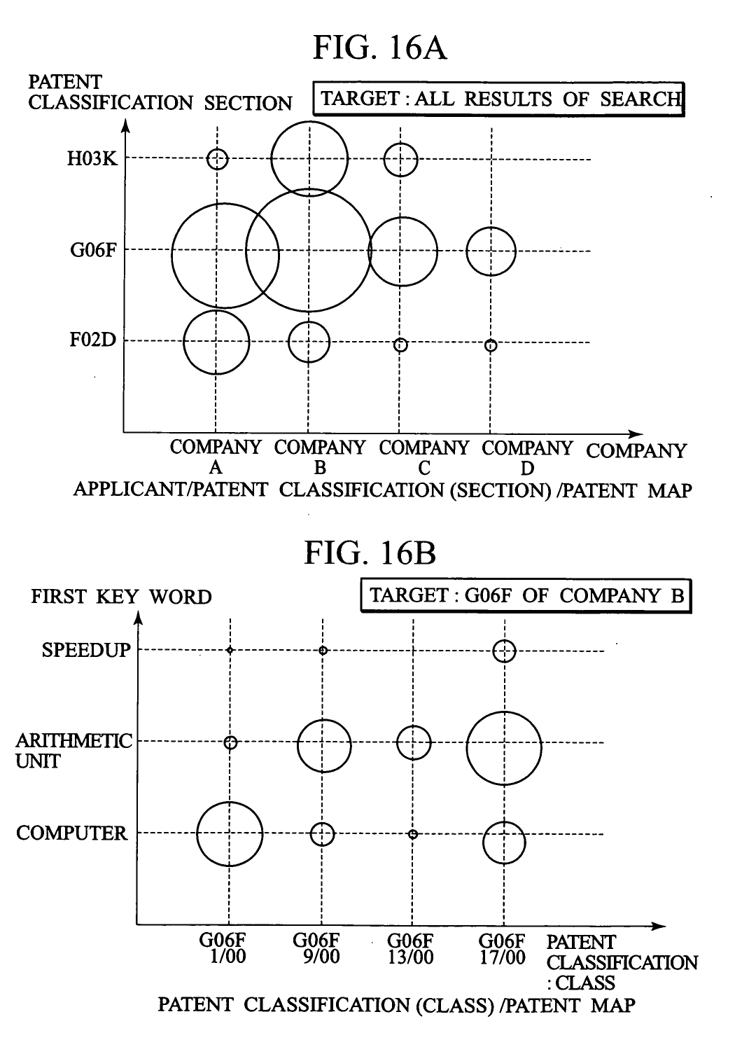

In addition, summarize the relevant information may be executed by total item where either of the first key word and the second key word includes one or more. At this time, the distribution map as shown in FIG. 15 where the relation between summarized relevant information and total item is shown is preferably generated.

In the distribution map shown in FIG. 15, the relevant information is summarized by the first key word and the second key word extracted by the research section 32.

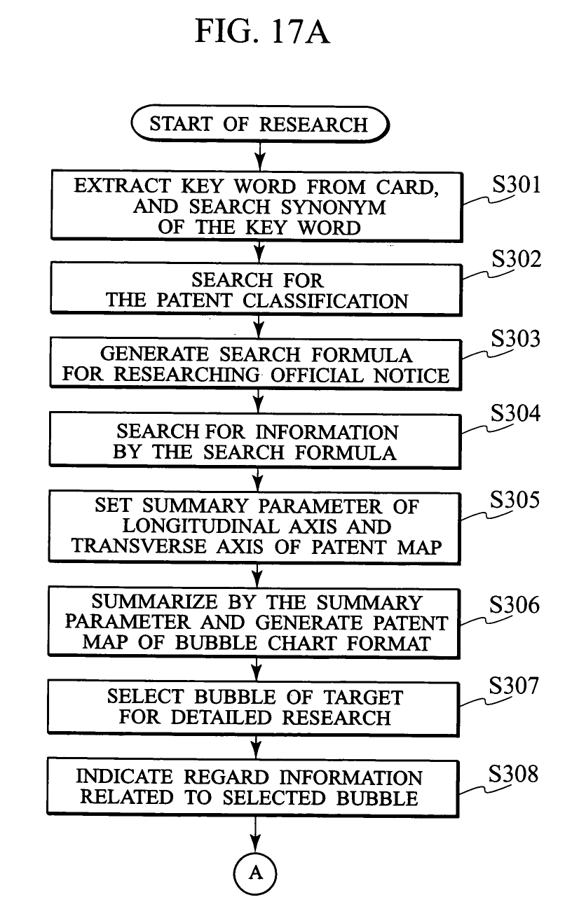

In particular, when the search target information is information for the specification of the filed patent application, the total item further includes either one or more of the patent classification, the application filling date, the applicant, or the inventor preferably. At this time, the distribution map that the research section 32 generates is a patent map for example, shown in FIGS. 16A and 16B preferably.

Moreover, the research section 32 may relate the second keyword to items described the second key word in and the official notice, such as “Claims” and “Prior art” and may store it in the research results marking storage unit 19.

Research section 32 will be explained in detail indicated patent map. FIG. 16A is an example of the search results summarized and displayed, is summarized by using the section of the patent classification and applicant's item, and is a bubble chart of the number of cases shown by the size of the bubble. When FIG. 16A is referred, how much number of cases to which classification the applicant are filed is understood at one view. At this time, it is possible to refer in detail the application filed for example by “Company B” by “G06F” as shown in FIG. 16B by selecting the bubble. In FIG. 16B, the application to which “Company B” files by “G06F” is summarized by using the class of the patent classification and the item of the first key word for the search key of the search formula. Here, the summary is executed by using the first key word to bracket the synonym, the broad term, and the narrow term, etc. preferably.

Although the bubble chart is used as the patent map in FIG. 15 and FIGS. 16A to 16B, it is not limit to the bubble chart, and is acceptable also as a bar chart, a line chart, a pie chart, and a three-dimensional bar chart, or the like.

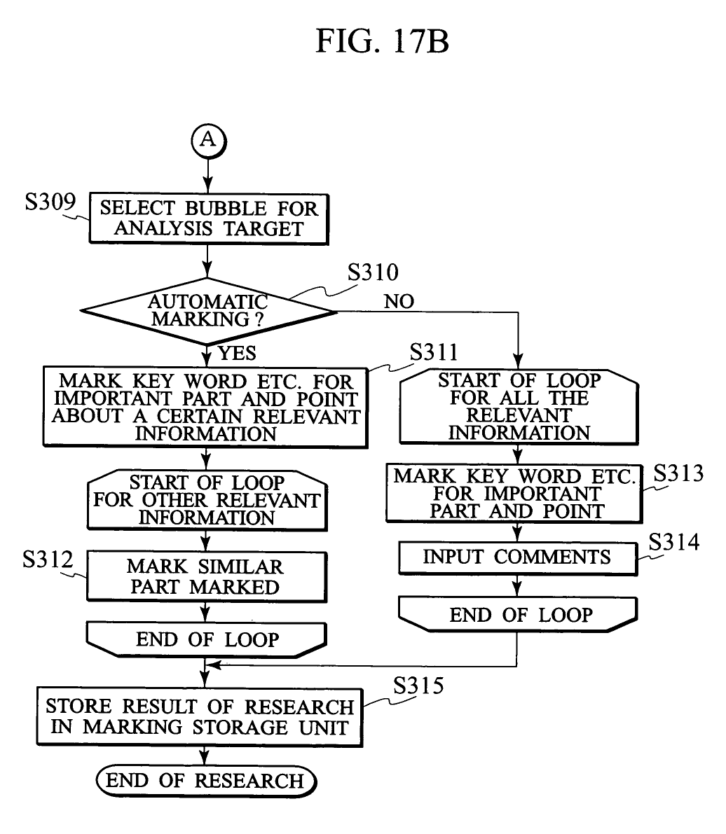

Next, the search procedure will be described in detail referring to FIGS. 17A to 17B.

First of all, in Step S301, search for the natural word executed by using the words stored in the first analysis results of the idea generation storage unit 14, and the first key words of the noun and the verb, etc. are extracted. At this time, the search refinement may be further executed by using the first key word extracted from the research section 32. In addition, the synonym of the extracted invention key word is acquired referring to the synonym dictionary storage unit 12. For example, in the case where the search key includes “Computer”, searching including these synonyms, broad terms, and the narrow terms are executed. At this time, the search is not executed for all search terms but also “Search only by the synonym”, “Search by the synonym and the broad term”, etc. may be selected.

Next, in Step S302, the search for the patent classification that relates to this business method is executed from the first key word extracted at Step S301 referring to the patent classification storage unit 912 etc. This Step may be omitted when not searching for specification information filed the patent application.

Next, in Step S303, the search formula for the research is generated from the invention key word and the patent classification, etc. acquired in Step S301 and Step S302, and stores it in the search parameter storage unit 15. At this time, it is preferable to search of the “OR” operation for the synonym related to the first key word, and is preferable to search of “AND” operation for the first keyword and patent classification.

Next, in Step S304, the search for the relevant information is executed referring to the document storage unit 17, the application document storage unit 16, the publication storage unit 911,921, and 931 storing the patent published application, and the contents storage unit 941 . . . etc. by using the searching parameter stored in the search parameter storage unit 15, and the results is stored in the research results storage unit 18.

Next, in step S305, when the bubble chart that indicates the relation between the relevant information and the item is generated, the summary parameter of the longitudinal axis and the transverse axis of the patent map is set. The summary parameter may be setup based on the predetermined algorithm stored in the research section 32, or may be set by inputting via the input unit. When the summary parameter is set, in step S306, the relevant information searched at step S304 is summarized by using the summary parameter set at step S305, the distribution map of the bubble charts as shown in FIG. 15, and FIGS. 16A to 16B are generated and indicated.

Here, for example, in the case where the bubble for the detailed research shown in FIG. 16A is selected in Step S307, the bubble chart that summarizes the relevant information related to the selected bubble by using a summary parameter as shown in FIG. 16B different from the summary parameter shown in FIG. 16A is indicated in Step S208. The distribution maps of a variety of bubble chart forms are generated like this, the bubble for the analyzed target is selected, and the relevant information related to this bubble is acquired. In addition, the bubble for the analysis object is selected, and the relevant information for the analysis object is extracted in Step S309.

Next, the second key word that characterizes the relevant information is put a mark for the relevant information extracted by Step S309. In this case, there is a method that the second key word is decided by inspecting certain relevant information and the research section 32 marks about other relevant information by the automatic operation and a method that inspects all relevant information and generates it by the manual operation.

When putting a mark by the automatic operation, first, certain relevant information is indicated on the display unit, the key words etc. are put a mark through the input unit for an important part and point as the second key word, and acquired it in Step S311. In Step S312, the key word is marked similar to the second key word marked at Step S308 about all other relevant information.

On the other hand, when putting a mark by the manual operation, all relevant information is indicated in the display unit, the key word etc. for an important part and point as the second key word are put a mark through the input unit, and acquired it in Step S313. At this time, the comment may be input by the person in charge to inspect the relevant information in Step S314.

When marking of the relevant information completes, in Step S315, the results of marking is stored in the research results marking storage unit 19. In addition, when the comment is input in Step S314, this comment is preferably stored in the research results marking storage unit 19.

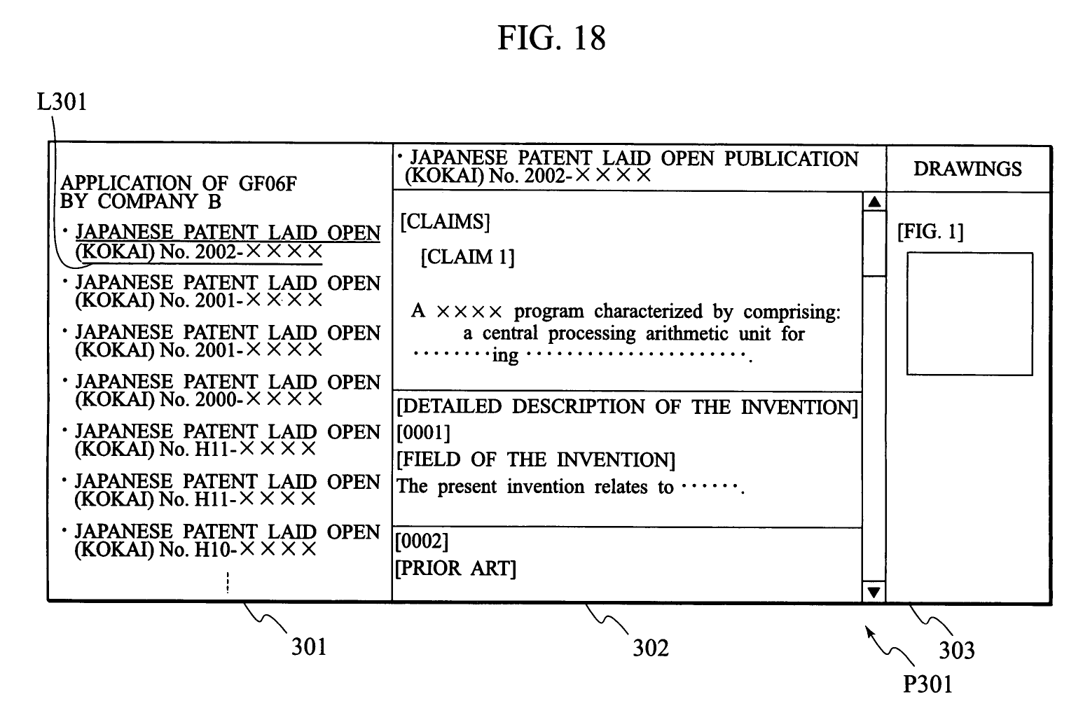

Referring to FIG. 18, when the relevant information is put a mark at Step S311 and Step S313 shown in FIG. 17B, indicating a relevant information indicating window P301 will be described. Here, the publication of the specification filed as the patent application will be described as the relevant information.

The relevant information indicating window P301 includes a target publication list indicating section 301, a target publication detailed indicating section 302, and a figure indicating section 303.

As for the target publication list indicating section 301, the official notice that is the relevant information for the target of marking is displayed in list form. More specifically, for example, in the patent map shown in FIG. 16A, the official notice related to the bubble of which the applicant is “Company B” and the patent classification is “G06F” is displayed in list form. As for these official notices, a publication indicating link L301 is provided respectively, and when the publication indicating link L301 is clicked, the selected publication is indicated in the target publication detailed indicating section 302.

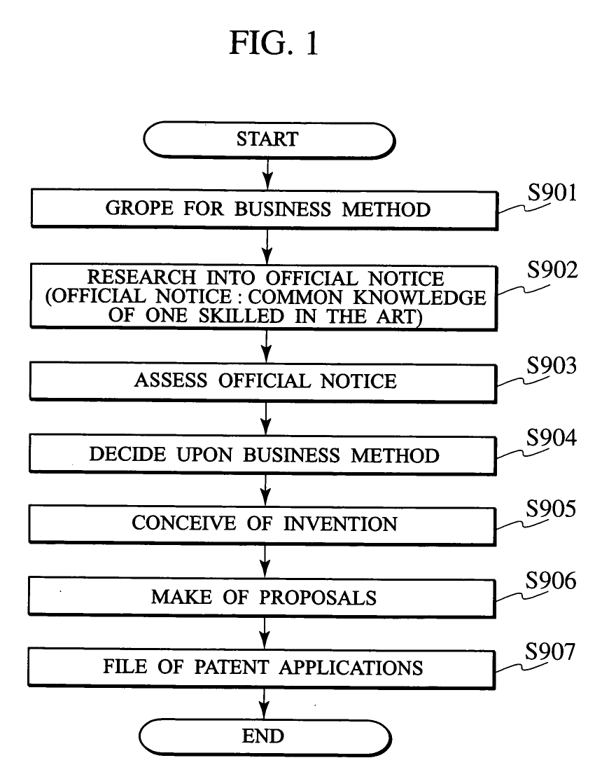

The target publication detailed indicating section 302 indicates separately each item of the specification. Here, in the case where “Central processing arithmetic unit” or “Program” is selected by using the mouse etc., the selected words are stored as a second key word. At this time, it is related to the item of the specification and is stored preferably. A link to indicate the figure is provided in the description such as “FIG. 1” of the publication, and when this link is clicked, the relevant figure is indicated in the figure indicating section 303.

Even if the research section 32 according to the preferred embodiment of the present invention doesn't depend on the person in charge of the research of working full-time, a cutting edge engineer easily can generate the search formula and can research by his self. Therefore, it is possible to research sufficiently, and to reflect it in a novel business.

### Assessment Analysis Section

Next, the assessment analysis section 33 of the information processor 1 according to the preferred embodiments of the present invention will be described referring to FIG. 4.

The assessment analysis section 33 is a section for receiving the correlation of the target information to be searched and the relevant information. Here, “Target information to be searched” is information conceived by the first idea generation support section 31. “Correlation” is information of the utility and the relevancy etc. of the relevant information to target information to be searched.

In particular, in the case where the relevant information is information of the specification filed as a patent application, there are “None assessment”, “Whether or not requirement to the pursuit research”, “Right or wrong of diverting to the proposals information”, and “The relevancy with information of the specification filed patent application” etc. as the correlation.

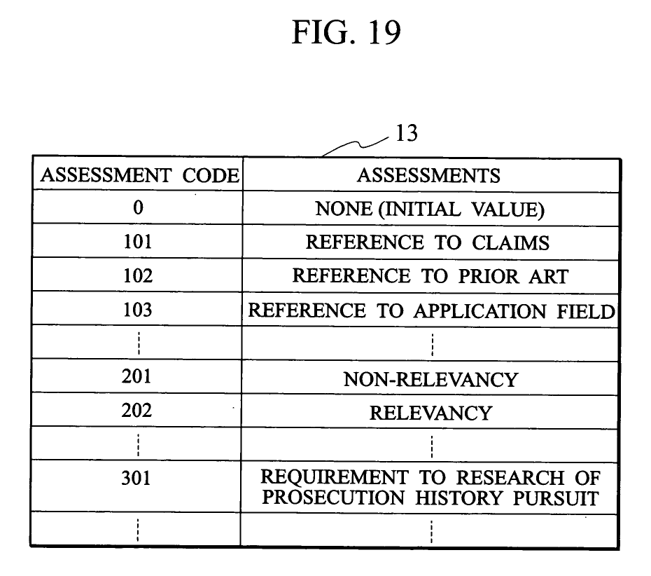

Moreover, the correlation assessed by the assessment analysis section 33 is preferably executed referring to the assessment code storage unit 13 shown to FIG. 19. For example, at least one or more of among “None assessment” as the default, “Whether or not requirement to research of prosecution history pursuit”, “Right or wrong of diverting to target information to be searched” and “The relevancy with target information to be searched” should be related. In particular, in a case where the relevant information is information of the specification filed patent application, the item of “Claims” and “Prior art”, etc. in the relevant information for diverting should be related.

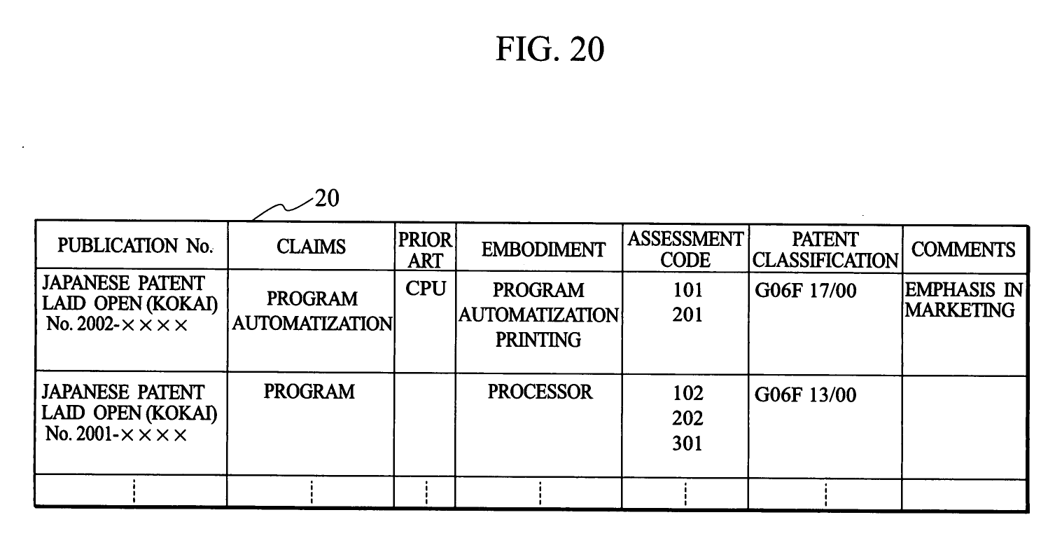

The assessment analysis section 33 may assess the relevant information referring to the searched relevant information stored in the research results storage unit 18 and the second key word stored in the research results marking storage unit 19. The assessment analysis section 33 stores the assessment results in the assessment analysis results storage unit 20 as shown in FIG. 20. Here, the item in the relevant information described the second key word and the second key word stored in the research section 32 may be preferably related. In FIG. 20, the assessment analysis results storage unit 20 is described in the case of the specification information for filing of patent application about the relevant information.

As shown to FIG. 20, the assessment analysis results storage unit 20 relates and stores the Publication Number identified the official notice, the description position and the key word of the official notice, the assessment code provided to the official notice, the patent classification, and the comment, etc. for each official notice that is the relevant information. The comment inputted at Step S314 of FIG. 17A, and stored it in the research results marking storage unit 19 is also preferably succeeded by into the assessment analysis results storage unit 20.

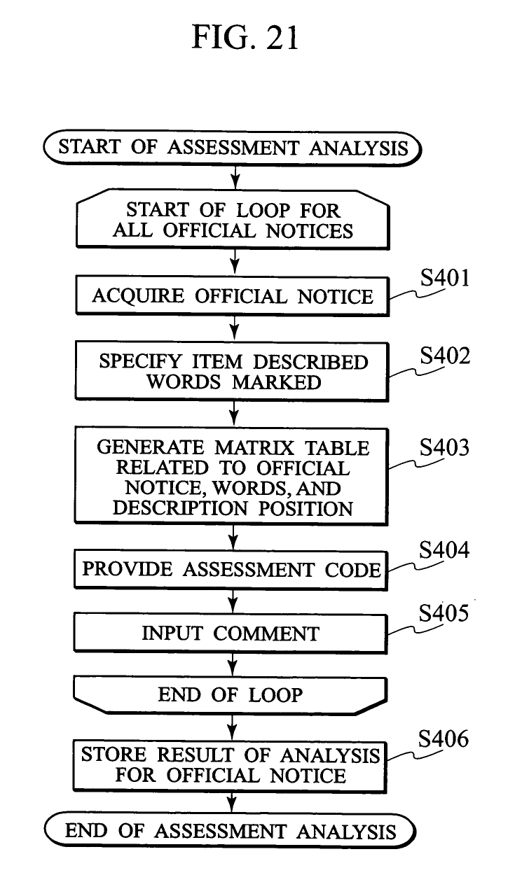

Next, the assessment analysis method of the relevant information will be described in detail referring to FIG. 21. Here, in the case of the relevant information that is the information of the specification filed patent application will be described.

First of all, in Step S401, the official notice of the target for the assessment analysis is acquired and indicating. At this time, the second key word is preferably marked for ease to identify by changing the background color and the font color referring to the research results marking storage unit 19.

Next, the item described the second key word marked is specified in Step S402. In addition, the matrix table where the official notice, the second key word, and the item, which the second key word described in, are related is generated and indicated in Step S403. Furthermore, in Step S404, the official notice is assessed referring to the assessment code storage unit 13. In Step S405, the comment is inputted if there is a comment to be input.

This Step S401 to Step S405 is executed about all official notices of the assessment.

When the assessment analysis of all official notices completes, the results are stored in the assessment analysis results storage unit 20 in step S406.

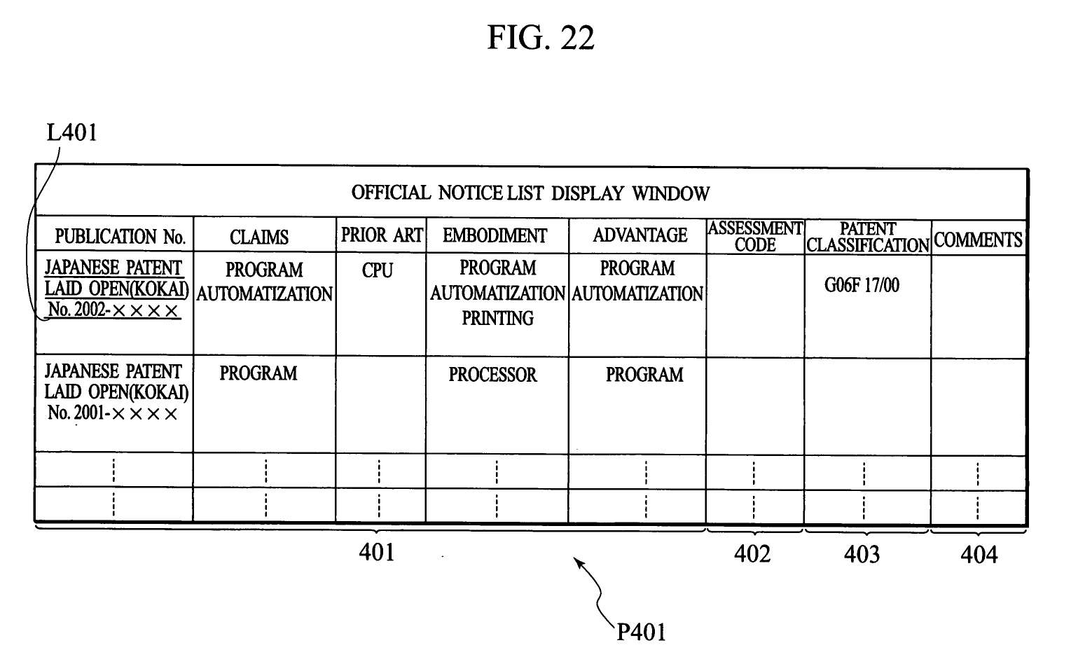

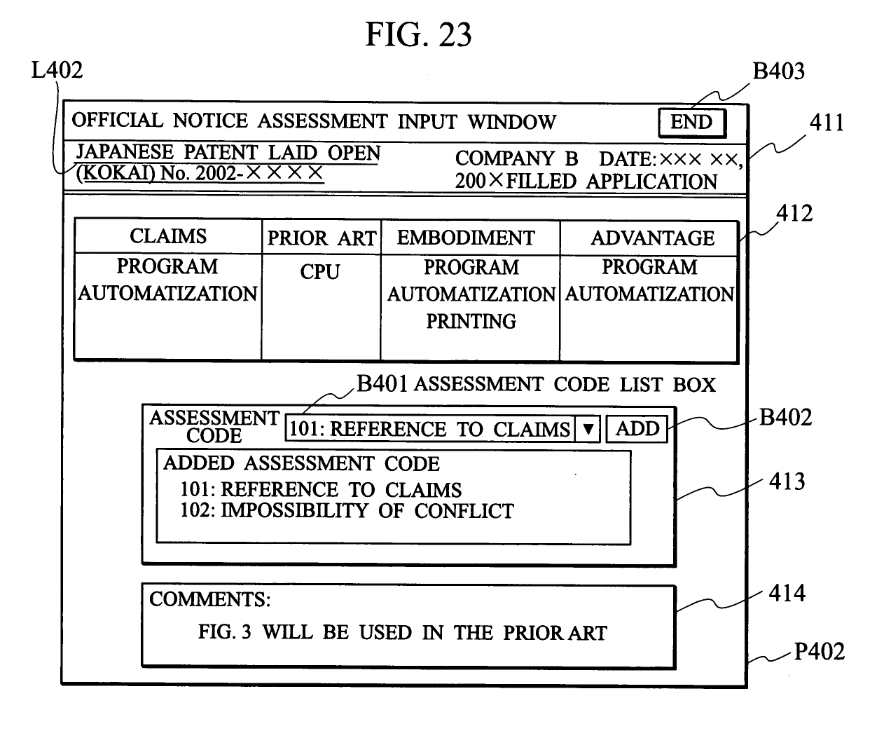

One example of the window indicated by the assessment analysis section 33 will be described referring to FIG. 22 and FIG. 23. Here, a case in which the relevant information that is the information of the specification filed patent application will be described.

In the case where the official notice is assessed, a publication list indicating window P401 shown to FIG. 22 is presented. The publication list indicating window P401 displays the official notice for the assessment in list form, and includes a marking words indicating section 401 for relating the marked second key word and the item described the second key word, an assessment code indicating section 402 for indicating the assessment code about the official notice, the patent classification indicating section 403 for indicating the patent classification of the official notice, and the comment indicating section 404 for indicating the comment on the official notice. Since until Step S403 of FIG. 21 has been executed before the assessment, the marking words indicating section 401 and the patent classification indicating section 403 only have been displayed beforehand as shown to FIG. 22. The assessment code indicating section 402 and the comment indicating section 404 are also displayed by assessing each official notice in Step S404 of FIG. 21.

An assessment input window indicating link L401 is provided in the Publication Number shown in FIG. 22. When the assessment input window indicating link L401 is clicked, the official notice assessment input window P402 for inputting the assessment of this official notice shown to FIG. 23 is indicated.

The official notice assessment input window P402 includes a bibliography items mentioned indicating section 411 for indicating the Publication Number of the official notice and the bibliography items mentioned of the applicant etc. and a marking indicating section 412 for indicating the official notice key word marked, an assessment input section 413 for inputting the assessment, and a comment input section 414 for inputting the comments.

The publication indicating link L402 is provided in the Publication Number of the bibliography items mentioned indicating section 411, and when the publication indicating link L402 is clicked, the full text of the publication is indicated.

When the official notice assessment input window P402 is firstly indicated, the assessment input section 413 and the comment input section 414 are in the state of the blank column. The assessment input section 413 includes an assessment code list box B401 inputted the assessment code and the assessment stored in assessment code storage unit 13, and an “add” button B402. An appropriate assessment is selected from the assessment code list box B401, and when the “add” button B402 is clicked, the assessment is input to an “Added assessment code” column. In addition, the comment input section 414 can be input the textual input.

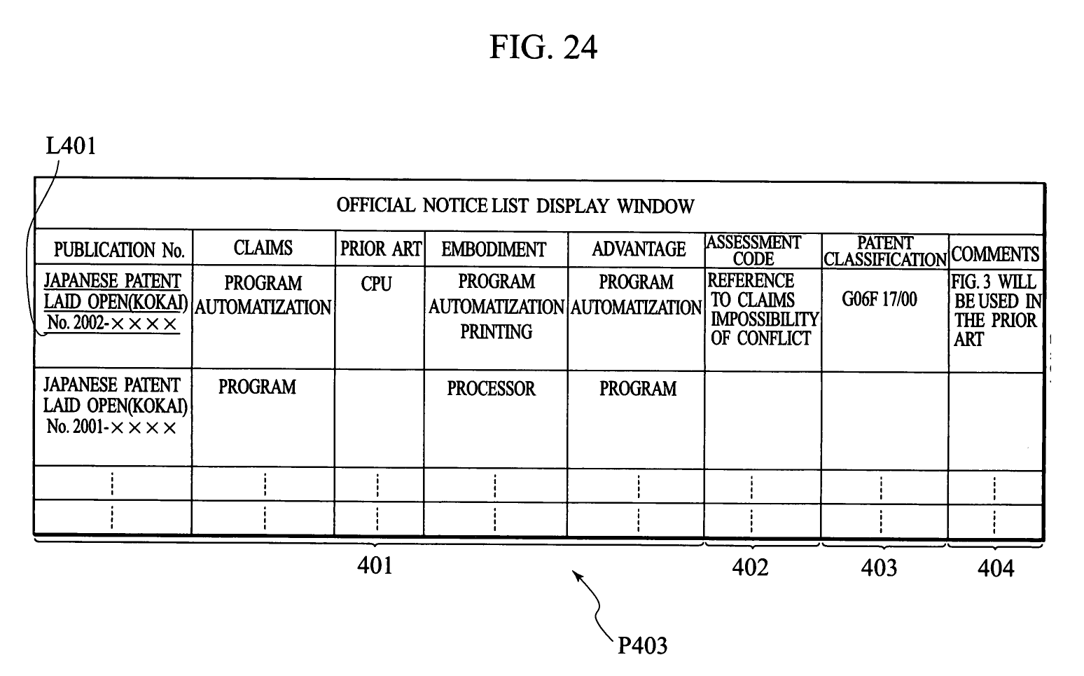

When the assessment concerning the official notice is completed and an “end” button B403 is clicked, the publication list indicating window P403 shown to FIG. 24 reflected of the assessment code and the comment, etc. inputted at in FIG. 23 is indicated.

### Second Idea Generation Support Section

Next, the second idea generation support section 34 of the information processor 1 according to the preferred embodiments of the present invention shown to FIG. 4 will be described.

The second idea generation support section 34 is a section that embodies and supports enhancing the idea conceived by the first idea generation support section 31 referring to the assessment analysis results storage unit 20 and the first analysis results of the idea generation storage unit 14. In particular, when a patent application is filed, the idea is enhanced even to the invention for which a patent application can be filed in the second idea generation support section 34.

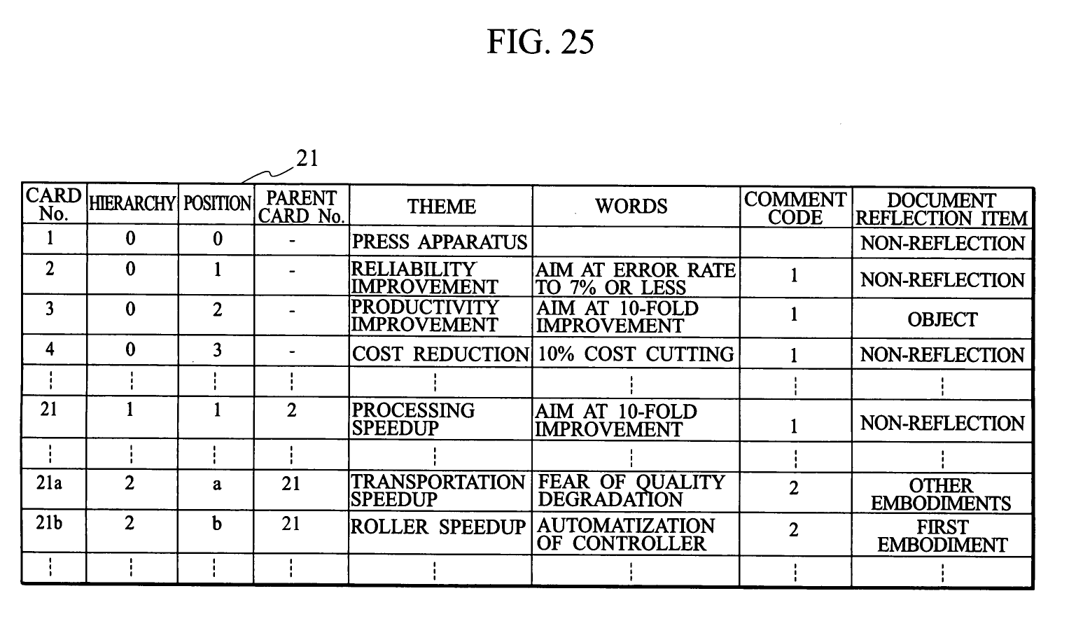

In addition, whether or not the unit information conceived by the second idea generation support section 34 is reflected in the proposals of the filing of patent applications and the document of the project proposal etc. is decided, and the description item of the document for the reflection is decided, and it stores them in second analysis results of idea generation storage unit 21 shown in FIG. 25. The second idea generation support section 34 is executed based on the unit information hierarchically related by the first idea generation support section 31, and the unit information in the first idea generation support section 31 and the unit information in the second idea generation support section 34 are related hierarchically.

Moreover, the unit information in the second idea generation support section 34 is hierarchically preferably related as well as the unit information hierarchically related in the first idea generation support section 31.

As shown to FIG. 25, the second analysis results of idea generation storage unit 21 is a structure to add “Document reflection item” to the first analysis results of the idea generation storage unit 14. The “Document reflection item” are decided. The “Document reflection item shows whether or not each card shown to FIG. 10 reflects in the document, and shows in which item in the document is reflected in the case of the reflection in the document.

When the patent applications for the conceived idea are filed, the document reflection items are “Purpose” and “The first embodiment”, etc.

In the case where the idea is inspected enough by the first idea generation support section 31, the second idea generation support section 34 may not be necessarily executed.

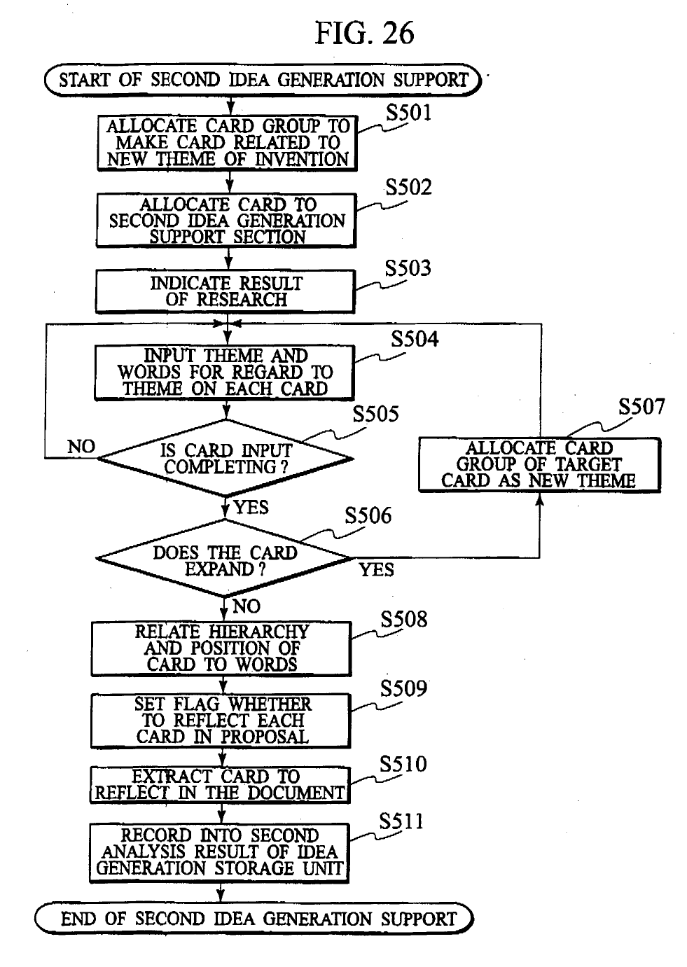

Next, the second idea support method will be described in detail referring to FIG. 26. Here, in a second idea generation support section 34, in the case to enhance the idea inspected by the first idea generation support section 31 to the contents approved as an invention will be described.

First of all, the blank card group concerning the theme of the invention is allocated in Step S501, and the information stored in the first analysis results of the idea generation storage unit 14 is projected in Step S502. On the other hand, the information stored in the assessment analysis results storage unit 20 is indicated in Step S503.

In addition, the theme and the word for regard to the theme are inputted on each card in Step S504. In step S505, Step S504 is executed until the input of the card is completed.

On the other hand, when the input of the card is completed in Step S505, whether or not the card is expanded is determined in Step S506. When expanding, in Step S507, the card group is allocated so that the card of the target is assumed to be a new theme, and Step S504 to Step S505 is executed repeatedly.

In Step S506, when expanding the card is completed, the hierarchy and the position of the card are related to the word in Step S508. In Step S509, the comment code stored in the idea generation comment code storage unit 11 is associated, and it is decided whether or not each card is reflected in the document.

In addition, only the card of the reflection in the document is extracted in Step S510, and stores in the second analysis results of the idea generation storage unit 21 in Step S510.

In the second idea generation support section 34, the window described in FIG. 10 similar to the first idea generation support section 31 is indicated.

### Documentation Support Section

Next, the documentation support section 36 of the information processor 1 according to the preferred embodiments of the present invention shown to FIG. 4 will be described.

The documentation support section 36 is a section for generating the document from the target information to be searched and the relevant information on the basis of the correlation received by the assessment analysis section 33. In addition, the document may generate referring to second analysis results of the idea generation storage unit 21. Here, “Document” is the project proposal of a new product and the business method, and the application specifications for filing the patent application and/or the invention proposals that summarize or the descriptions of the specification etc.

The documentation support section 36 extracts the unit information of the reflection in the document referring to the first analysis results of the idea generation storage unit 14 or second analysis results of the idea generation storage unit 21, and relates the description item of the document that is the reflection of extracted unit information. In addition, the document is generated by putting together plural unit information by the description item, and stored in the document storage unit 17.

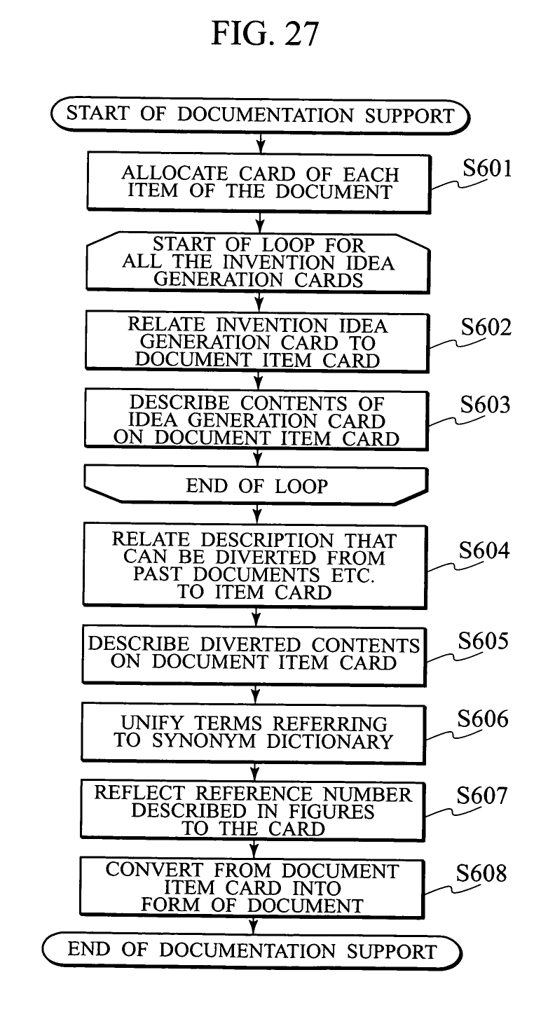

The documentation supporting method will be described referring to FIG. 27.

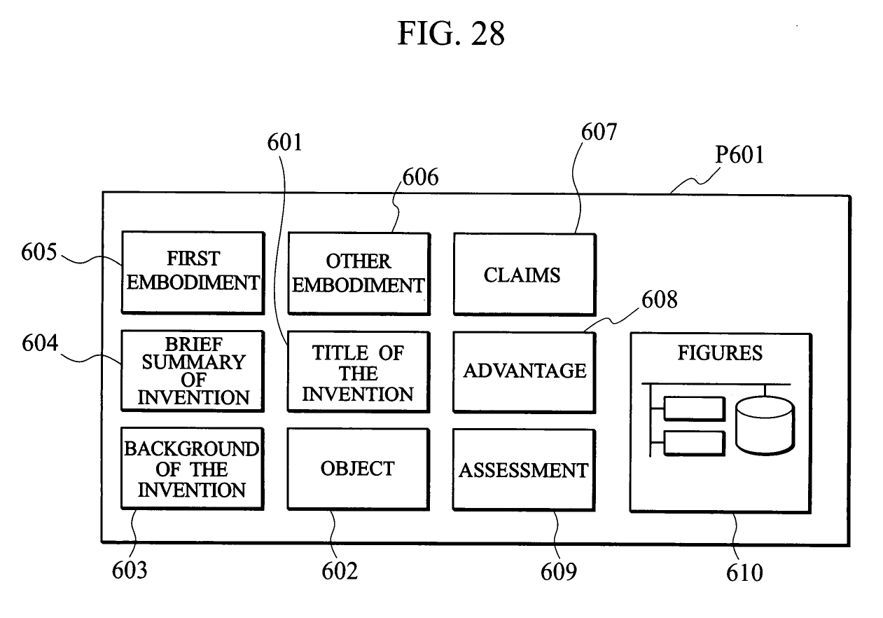

First of all, in step S601, the card of each item of the document is allocated as shown to FIG. 28.

Next, the document item card shown in FIG. 28 and the conceived unit information is related referring to the first analysis results of the idea generation storage unit 14 and/or the second analysis results of the idea generation storage unit 21, and the unit information is described on the document item card. In addition, the detailed information may be described if necessary. The processing of Step S602 and Step S603 are executed with respect to all the item cards.

Next, in Step S604, the description that can be diverted from the past proposals etc. and the document item card are related referring to the assessment analysis results storage unit 20. In Step S605, the diverting contents are described on the document item card.

In addition, in Step S606, terms are unified referring to the synonym dictionary storage unit 12. Moreover, when there is a figure(s), the reference number described in the figure and the device name are associated, and the terms are unified in Step S606.

In addition, in step S608, it converts from the document item card into the form of the document, and generates the document.

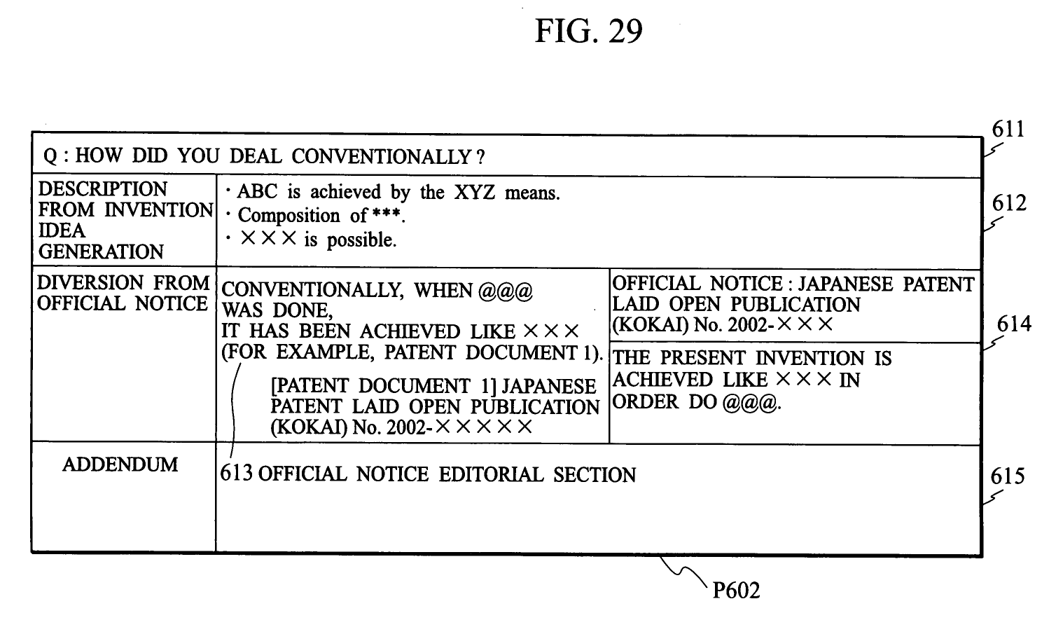

One example of a window indicated by the documentation support section 36 will be described referring to FIG. 28 and FIG. 29. Here, a case in which there is generation of the invention proposals that summarize the description of the specification filing of patent applications as a document will be described.

FIG. 28 shows an invention proposals generating support window P601 for generating the invention proposals. The Invention proposals generating support window P601 includes the title of an invention item section 601 for describing the title of the invention, an object item section 602 for describing the object, an official notice item section 603 for describing the official notice, a brief summary of the invention item section 604 for describing the outline of the invention, a first embodiment item section 605 for describing the first embodiment, an other embodiment item section 606 for describing other embodiments, a claim item section 607 for describing the claims, an advantage item section 608 for describing the advantageous effect of the invention, an assessment item section 609 for describing the assessment on the business and the superior's assessment, and a figure item section 610 for describing the figure.

The unit information of the card is described in the item associated by the second analysis results of the idea generation storage unit 21 beforehand in these items. In addition, the part for diverting from the research results storage unit 18 is diverted referring to the assessment analysis results storage unit 20.

In addition, the documentation support section 36 may further describe each item in detail.

For example, when details are described about the prior art, the documentation support section 36 indicates the prior art register window P602 as shown in FIG. 29.

The prior art register window P602 includes a title section 611 corresponding to the item of the invention proposals, an invention idea generation description indicating section 612 for indicating the description from the invention idea generation, an official notice editorial department 613, an official notice indicating section 614, and an addendum editorial section 615.

The documents set as “Reflection in the prior art” are indicated in the official notice indicating section 614, in the past proposal contents and the official notice. The official notice indicating section 614 is made to refer, and transcribe to the official notice editorial section 613 and edit it. In addition, the addendum editorial section 615 is made to describe when desiring to add and describe.

### Foreign Document Analysis Section

Next, the foreign document analysis section 35 of the information processor 1 according to the preferred embodiments of the present invention shown to FIG. 4 will be described.

The foreign document analytical tool 35 is a section for comparing the searching target information on the same searching target information by the contents described in each language in each country, comparing the words used by each country, and generating the translation with an original with the original in each country corresponding to the words.

For example, in a case where the searching target information is the specification information filed as a patent application, the patent family is searched for a certain official notice and stored in the patent family storage unit 22. And then, the words used by the official notice are compared with one or more of either the official notice or the filed country, the translation with the original in each country corresponding to the words is generated and stored in the foreign language bilingual storage unit 23.

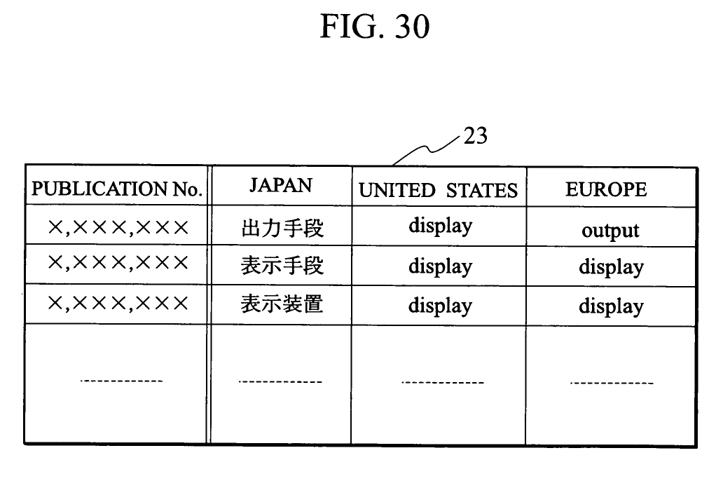

As shown to FIG. 30, the foreign language bilingual storage unit 23 includes the Publication Number and the item in each country. The words of used in the foreign application are associated with each Publication Number. Here, the information of these each Publication Numbers is accumulated.

At this time, the words used mutually in Japan may be compared by accumulating the information of each Publication Number and comparing the similarities of the words in Japan, the United States, and Europe.

For the example of FIG. 30, it is assumed that the words “Shutsuryoku Shudan” (Japanese word meaning “Display” or “Output” in English), “Hyouji Shudan” (Japanese word meaning “Display” in English), and “Hyouji Souchi” (Japanese word meaning “Display” in English), are used in the Japan. Even if only words used in Japan are compared, whether the words of “Shutsuryoku Shudan”, “Hyouji Shudan”, and “Hyouji Souchi” have a similar meaning cannot be determined.

Here, by searching for the patent family of the predetermined publication and comparing the words, it is assumed that the word “display” is used in the United States, and the word “output” is used in Europe as the parallel translation for the words “Shutsuryoku Shudan” used in Japan. Moreover, in another publication, it is assumed that the word “display” is used in the United States, and the word “display” is also used in Europe as the parallel translation for the words “Hyouji Shudan” used in Japan.

In this case, by searching for the words in the Japan as a key words “display” used in the United States and Europe, it may be determined that “Shutsuryoku Shudan”, “Hyouji Shudan”, and “Hyouji Souchi” are used in the same meaning. In addition, it may be determined that “display” and “output” are used in the same meaning.

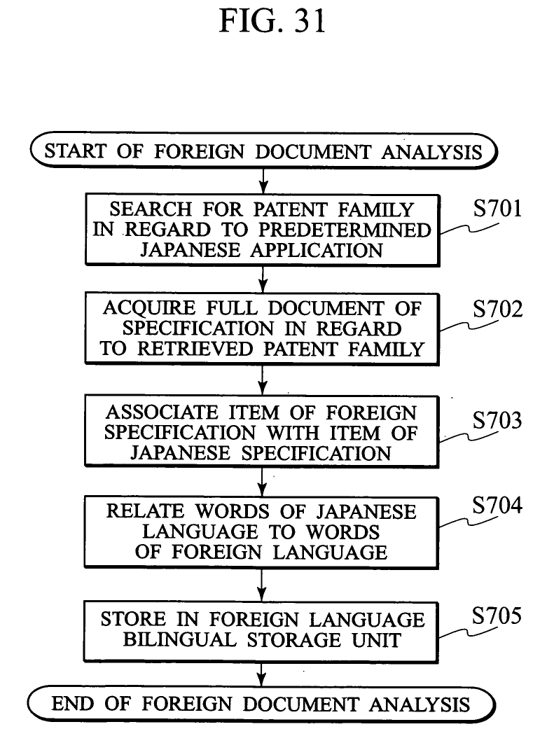

The foreign document analytical method will be described referring to FIG. 31. Here, a case where the search target information is the specification filed patent application will be described.

First of all, in Step S701, a search for the patent family that is the same application contents is executed referring to the United States publication storage unit 921 and the European publication storage unit 931, etc., in regard to the predetermined Japanese application. In Step S702, the specification full text of the patent family is acquired and stores in the patent family storage unit 22.

Next, in Step S703, the item of the foreign specification is associated with the item of the Japanese specification. The words of Japanese are related to the words of foreign language in Step S704 and stores in the foreign language bilingual storage unit 23 in Step S705.

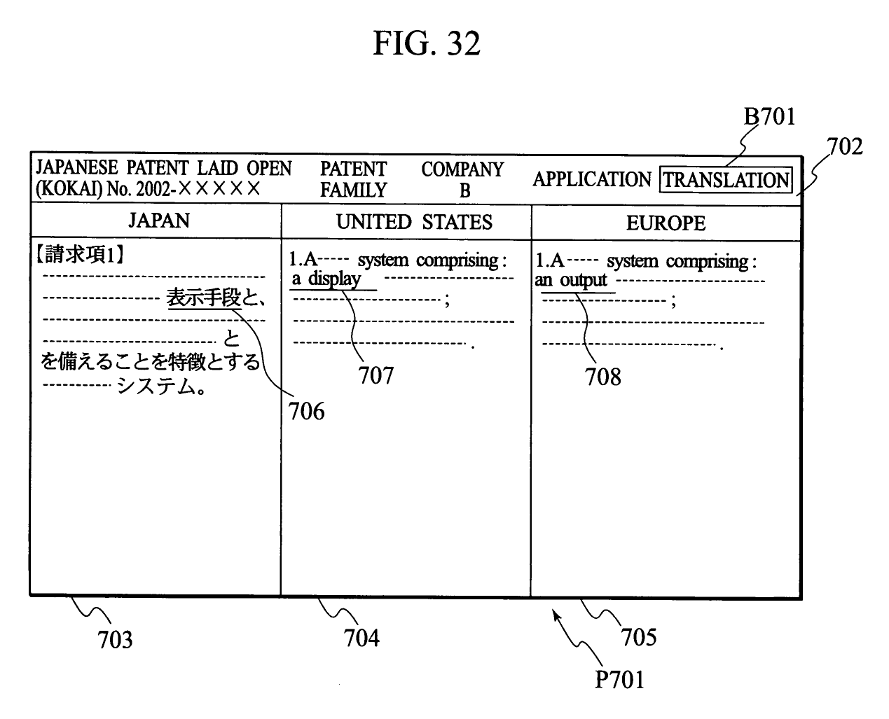

Next, an example of a window of a patent family comparison window P701 for relating the words of Japanese to the words of foreign language will be described referring to FIG. 32.

The patent family comparison window P701 includes a title section 702, a Japanese specification indicating section 703, a United States specification indicating section 704, and a European specification indicating section 705, and the patent family comparison window P701 is a window for comparing the Claims. Japanese words 706 are related to United States words 707 and European words 708 corresponding to the Japanese words 706 by inspecting each patent family and selecting using the mouse etc. In the example shown in FIG. 32, it is assumed that “Hyouji Shudan” of Japanese words 706 is related to “display” of the United States words 707 and “output” of European words 708 as the translation with the original of the foreign language.

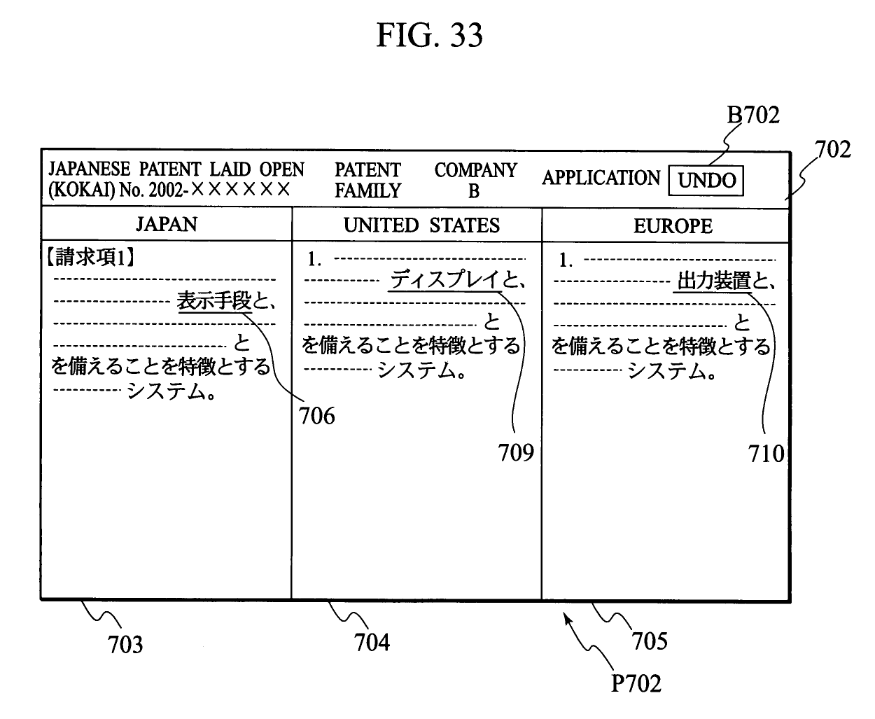

Moreover, a “translation” button B701 may be provided in the patent family comparison window P701. When the “translation” button B701 is clicked, the foreign document analytical tool 35 translates the document described in various languages into the prescribed language. For example, in the case where the document described in English is translated into Japanese, a Japanese translation window P702 of the patent family is indicated as shown in FIG. 33.

In FIG. 33, the United States words 707 shown in FIG. 32 translated into the words 709 is preferably identified. Similarly, the European words 708 translated into which the words 710 shown in FIG. 33 is preferably identified.

When an “undo” button B702 provided in FIG. 33 is clicked, the foreign document analytical tool 35 indicates FIG. 32 before the translation.

Although the case where the full text document is translated is described in FIG. 32 and FIG. 33, it may translate only the specified part or item of specification.

### Foreign Documentation Support Section

Next, a case where the foreign document used in the predetermined country is generated will be described referring to FIG. 4.

In the case of foreign documentation, the search formula stored in the search parameter storage unit 15 is translated into the language in the used country, and it searches by the research section 32, and relevant information is collected. And then, the assessment analysis of the collected relevant information is executed by the assessment analysis section 33, and is stored in the assessment analysis results storage unit 20.

In addition, the second idea generation support section 34 supplements the idea appropriate for the country and relates to the item of the invention proposals by referring to the assessment analysis results storage unit 20, and stores it in the foreign language analysis results of idea generation storage unit 24 with the structure similar to the second analysis results of idea generation storage unit 21. At this time, the second idea generation support section 34 the unit information described by appropriate words to the country is preferably stored to in the foreign language analysis results of idea generation storage unit 24 referring to the foreign language bilingual storage unit 23.

The foreign documentation support section 37 is a section for generating the appropriate document to the country where the document is used referring to foreign language analysis results of the idea generation storage unit 24 generated like this, and stores it in the document storage unit 17.

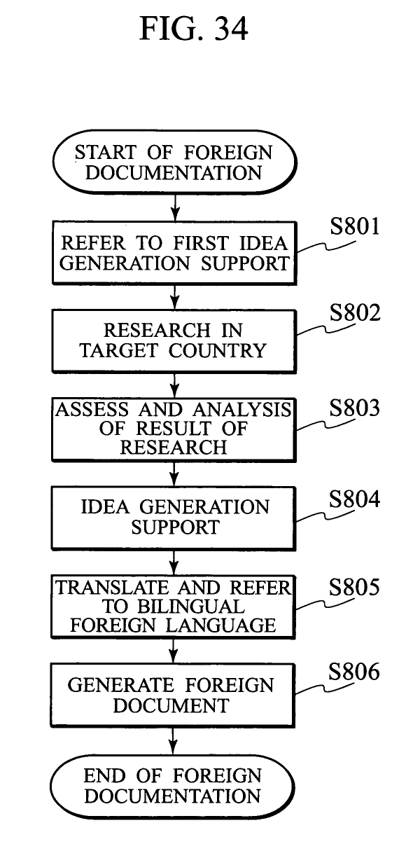

The foreign documentation method will be described referring to FIG. 34. Here, a case where the invention proposals appropriate for the foreign country filing of patent application are generated as the foreign document will be described.

First of all, referring to unit information stored in the first analysis results of the idea generation storage unit 14 in Step S801, the first key word is extracted by the research section 32, translated into the extracted key word into the language of the country filing of patent application, and the official notice is researched in Step S802, the assessment analysis of the official notice research is executed by the assessment analysis section 33 in Step S803.

Next, the invention idea generation support is executed by the second idea generation support section 34 in Step S804 based on the assessment analysis executed at Step S803. At this time, it stores it in the foreign language analysis results of the idea generation storage unit 24 in Step S805 referring to the foreign language bilingual storage unit 23.

In addition, the invention proposals corresponding to the country, which a patent application filed in, is generated by the foreign documentation support section 37, and stores it in the document storage unit 17 in Step S806.

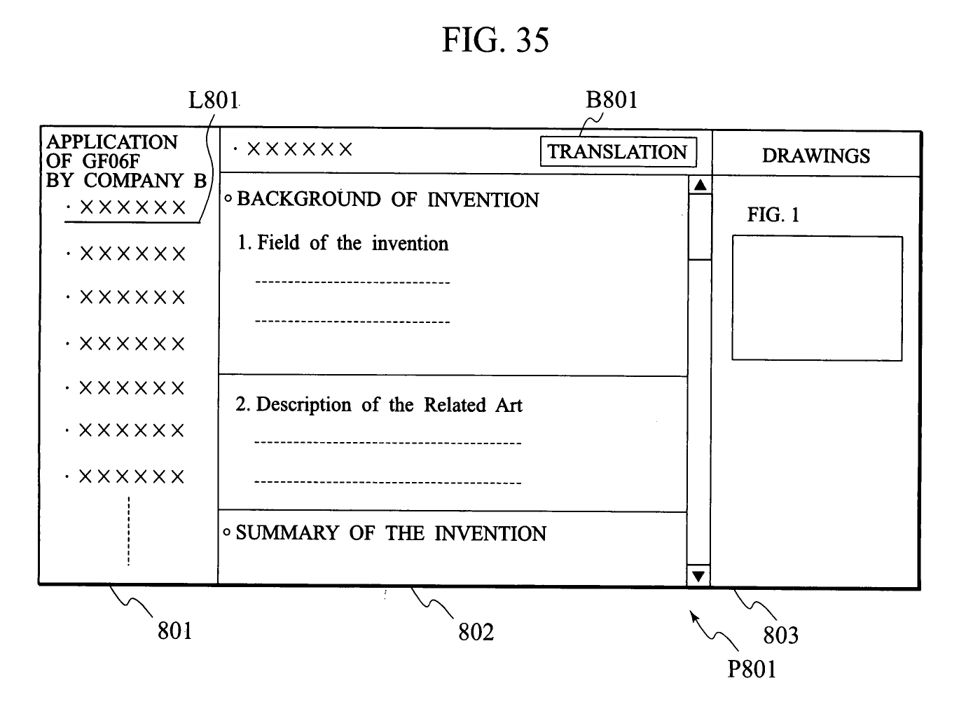

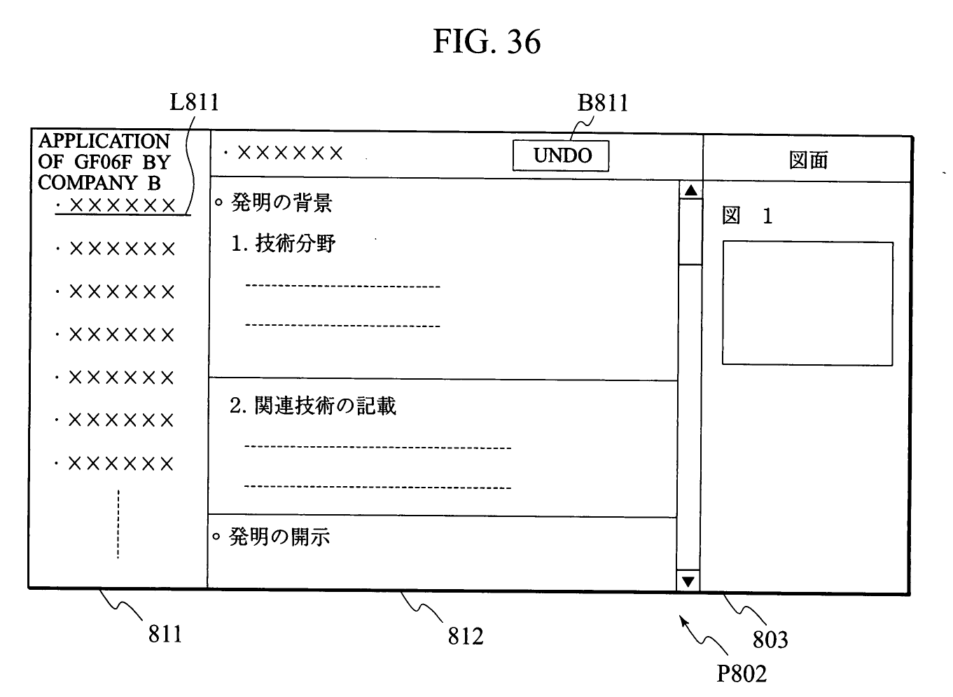

An example of a window indicated by the foreign documentation support section 37 will be described referring to FIGS. 35 to 37. Here, a case where the invention proposals for the foreign country filing of patent application are generated as the foreign document will be described.

FIG. 35 shows a window P801 indicated the relevant information of the foreign country searched for by the research section 32. A target publication list indicating section 801, a target publication detailed indicating section 802, and a figure indicating section 803 are included in FIG. 35 as well as FIG. 18. A publication indicating link L301 is respectively provided in the official notice presented in the target publication list indicating section 801, and when the publication indicating link L301 is clicked, the selected publication is indicated in the target publication detailed indicating section 302.

In FIG. 35, the point that a “translation” button B801 is provided is different. When the “translation” button B801 is clicked, the official notice shown to FIG. 36 translated is indicated on the window P802. When an “undo” button B811 provided in the window P802 is clicked, the window P801 not translated is indicated.

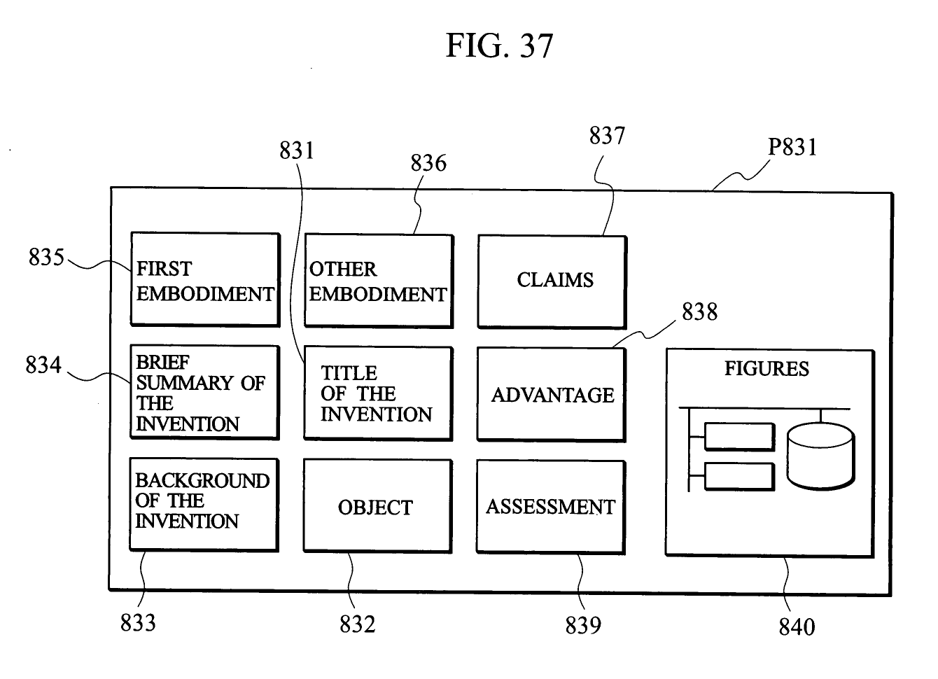

FIG. 37 shows a foreign invention proposals making support window P803 for generating the invention proposals of the foreign language. The proposals making support window P801 includes a title of the invention item section 831 for describing the title of the invention, an object item section 832 for describing the object, an official notice item section 833 for describing the official notice, a brief summary of the invention item section 834 for describing the brief summary of the invention, a first embodiment item section 835 for describing the first embodiment, an other embodiment item section 836 for describing the other embodiments, a Claims item section 837 for describing the Claims, an advantage item section 838 for describing the advantageous effect of the invention, an assessment item section 839 for describing the assessment of the business and the superior's assessment, and a figure item section 840 for describing the figures.

In these items, the contents of unit information are described in the item associated by the second analysis results of the idea generation storage unit 21 beforehand. In addition, the part for diverting from the research results storage unit 18 it is diverted referring to the assessment analysis results storage unit 20. In addition, the words corresponding to the translation with the original stored in the foreign language bilingual storage unit 23 are described in these items.

In addition, the foreign documentation support section 37 further may describe in detail the invention about each item as well as the documentation support section 36.

Since the information processor according to the preferred embodiments of the present invention can search for the relevant information such as the industry trend and patent information, etc. by arranging the conceived information, and by using the organized intelligence, it is effective for development of novel business, and for development and enhancement products and services.

Moreover, the relevancy of the relevant information and conceived information can be clarified by analyzing the searched relevant information, and by providing the comment.

In addition, the project proposal, the industry trend review report, and the document of the invention proposals etc. can be generated by referring to the information conceived by the information processor, relevant information the relevancy of the relevant information and the conceived information.

In particular, when information of the filing of patent applications is treated, the information processor according to the preferred embodiments of the present invention can execute everything from the idea generation of the business method to the filing of patent applications according to the consistent policy.

Moreover, since the system supports the work necessary for the filing of patent applications, it is possible to generate the search formula easily and to research by a cutting edge engineer independent of the person in charge of the research of working full-time.

In addition, the results of review of the official notice research are used effectively, and it is possible to generate the enhanced invention proposals.

In addition, for foreign applications, it is possible to generate the invention proposals for the appropriate foreign country based on the words and the strategy by referring to the foreign language bilingual storage unit 23, and referring to the assessment analysis results storage unit 20 in the foreign country.

Thus, the information processor according to the preferred embodiments of the present invention is effective for development of novel business, and for development and enhancement of products and services.

As mentioned above, although the preferred embodiments of the present invention have been described, it should be understood that the description and figures that achieves a part of this disclosure do not limit the present invention. A variety of alternative embodiments, examples and the management techniques will be clear to a person having ordinary skill in the art from this disclosure.

For example, although the preferred embodiments describe a case of filing a patent application, it may be used for a utility model, a design, or a trademark, and also used for project proposals, market research, and the like.

The present invention includes various embodiments etc. not described herein. Therefore, the technical scope of the present invention is indicated only by the invention specification according to the appropriate claims from the above-mentioned explanation.

### INDUSTRIAL APPLICABILITY

According to the present invention, it is possible to provide the available information processor and the information processing method effectively for development of novel business, and for development and enhancement of products and services.

1. An idea generation support section configured: to relate unit information of needs of a supplier of a product and unit information of needs of a user to predetermined comment code; to relate unit information of seeds of the product required from the needs of the supplier and the needs of the user to the comment code; and to summarize the unit information of the needs of the supplier, the unit information of the needs of the user, and the unit information of the seeds of the product by using the comment code.

2. The apparatus of claim 1, wherein
the comment code is a code rendered as indexes of one or more of the product configuration elements that is an attribute, an advantage, and a target of each of the unit information.

3. An apparatus for information processing comprising:
a research section extracting a first key word from target information to be searched, and searching for relevant information for regard to the first keyword from searching target information;
an assessment analysis section receiving a correlation between the target information to be searched including a using possibility of the relevant information for the target information to be searched and the relevant information; and
a document generation section generating a document from the target information to be searched and the relevant information on the basis of the correlation received by the assessment analysis section.

4. The apparatus of claim 3, wherein
in the case where the searching target information is information of a specification filed patent application, and the generated document is a specification to be filing patent application,
the correlation of the assessment analysis section further includes at least one or more of among “None assessment”, “Whether or not requirement to pursuit research”, the “Right or wrong of diverting to proposals information”, and “Relevancy with information of the specification filed patent application”.

5. The apparatus of claim 3, wherein
in the research section, the first key word is translated into a prescribed language, and the relevant information for regard to the first key word translated from the searching target information is searched.

6. An apparatus for information processing comprising
a research section configured: to extract a first key word from target information to be searched; to search for relevant information for regard to the first key word from searching target information; to extract a second key word for characterizing the relevant information; and to summarize the relevant information by summary item including one or more of the first key word and the second key word.

7. The apparatus of claim 6, wherein
in the research section, a distribution map for indicating the relation between the summarized relevant information and the summary item is generated.

8. The apparatus of claim 6, wherein
in the case where the searching target information is information of a specification filed patent application, the summary item further includes one or more of among patent classification, an application year, an applicant, and an inventor.

9. An apparatus for information processing comprising
a foreign document analysis section configured: to compare searching target information; to compares words used by each country; and to generate translation with an original in each country corresponding to the words, in same searching target information by contents described by using language in each country.

10. An apparatus for information processing comprising
a research section configured: to extract a first the key word from target information to be searched; to translate the first key word into a prescribed language; and to search for relevant information for regard to the translated first key word from searching target information.

11. A method for information processing comprising:
pursuing needs of a supplier for a product;
pursuing needs of a user for the product; and
pursuing seeds of the product to be realizable from the needs of the supplier and the needs of the user.

12. A method comprising
relating predetermined comment code to unit information of the needs of the supplier, unit information of the needs of the user, and unit information of the seeds of the product; and
summarizing each unit information by the related comment code.

13. The method of claim 11 or 12, wherein
the comment code is a code rendered as indexes of one or more of the product configuration elements that is an attribute, an advantage, and a target of each of the unit information.

14. A method for information processing comprising:
extracting a first key word from target information to be searched, and searching for relevant information for regard to the first key word from searching target information;
receiving a correlation between the target information to be searched including a using possibility of the relevant information for the target information to be searched and the relevant information; and
generating a document from the target information to be searched and the relevant information on the basis of the correlation.

15. The method of claim 14, wherein
in the case where the searching target information is information of a specification filed patent application, and the generated document is a specification to be filing patent application,
the correlation further includes at least one or more of among “None assessment”, “Whether or not requirement to pursuit research”, the “Right or wrong of diverting to proposals information”, and “Relevancy with information of the specification filed patent application”.

16. The method of claim 14, wherein
in the searching for relevant information, the first key word is translated into a prescribed language, and the relevant information for regard to the first key word translated from the searching target information is searched.

17. A method for information processing comprising
extracting a first key word from target information to be searched, searching for relevant information for regard to the first key word from searching target information, and extracting a second key word for characterizing the relevant information; and
summarizing the relevant information by summary item including one or more of the first key word and the second key word.

18. The method of claim 17, wherein
in the summarizing the relevant information, further generating a distribution map for indicating the relation between the summarized relevant information and the summary item.

19. The method of claim 17, characterized in that
in the case where the searching target information is information of a specification filed patent application, the summary item further includes one or more of among patent classification, an application year, an applicant, and an inventor.

20. A method for information processing comprising:
comparing searching target information; comparing words used by each country; and generating translation with an original in each country corresponding to the words, in same searching target information by contents described by using language in each country.

21. A method for information processing comprising:
extracting a first the key word from target information to be searched; translating the first key word into a prescribed language; and searching for relevant information for regard to the translated first keyword from searching target information.
